(19) United States
(12) Patent Application Publication
(10) Pub. No.: US 2022/0335962 A1
(43) Pub. Date: Oct. 20, 2022

(54) AUDIO ENCODING METHOD AND DEVICE AND AUDIO DECODING METHOD AND DEVICE

(71) Applicant: HUAWEI TECHNOLOGIES CO., LTD., Shenzhen (CN)

(72) Inventors: Bin WANG, Shanghai (CN); Bingyin XIA, Shanghai (CN); Zhe WANG, Shanghai (CN); Jiantong ZHOU, Shenzhen (CN)

(73) Assignee: HUAWEI TECHNOLOGIES CO., LTD., Shenzhen (CN)

(21) Appl. No.: 17/857,725

(22) Filed: Jul. 5, 2022

Related U.S. Application Data
(63) Continuation of application No. PCT/CN2021/070831, filed on Jan. 8, 2021.

(30) Foreign Application Priority Data
Jan. 10, 2020 (CN) 202010028452.6

(51) Int. Cl. G10L 19/02; G10L 19/22; G10L 25/18

(52) U.S. Cl. CPC G10L 19/0204; G10L 19/22; G10L 25/18

(57) ABSTRACT

An audio encoding method and device and an audio decoding method and device are provided. The audio encoding method includes: obtaining a current frame of an audio signal, where the current frame includes a high frequency band signal and a low frequency band signal; obtaining a compatible layer encoding parameter of the current frame based on the high frequency band signal and the low frequency band signal; obtaining an enhancement layer encoding parameter of the current frame based on the high frequency band signal; and performing bitstream multiplexing on the compatible layer encoding parameter and the enhancement layer encoding parameter to obtain an encoded bitstream.

### CROSS-REFERENCE TO RELATED APPLICATIONS

This application is a continuation of International Application No. PCT/CN2021/070831, filed on Jan. 8, 2021, which claims priority to Chinese Patent Application No. 202010028452.6, filed on Jan. 10, 2020. The disclosures of the aforementioned applications are hereby incorporated by reference in their entireties.

### TECHNICAL FIELD

This application relates to the field of audio signal encoding and decoding technologies, and in particular, to an audio encoding method and device and an audio decoding method and device.

### BACKGROUND

User requirements for audio services are increasingly high, and therefore, audio encoding/decoding devices need to be constantly updated. When a user requirement for a new audio service is met, it is also necessary to ensure that an old audio encoding/decoding device is fully compatible, so that the old audio encoding/decoding device can still provide an audio service. A key step in this case is that a new audio encoding/decoding device can be compatible with the old audio encoding/decoding device.

To enable the new encoding/decoding device to be compatible with the old audio encoding/decoding device, currently, a transcoding module needs to be deployed in the old audio encoding/decoding device. Interworking between the old audio encoding/decoding device and the new audio encoding/decoding device can be implemented by using the transcoding module. However, adding the transcoding module to the old audio encoding/decoding device increases costs of reconstructing the old audio encoding/decoding device, increases device complexity and energy consumption of the encoding/decoding device, and reduces audio signal encoding/decoding efficiency.

### SUMMARY

Embodiments of this application provide an audio encoding method and device and an audio decoding method and device, to implement compatibility between a new encoding/decoding device and an old encoding/decoding device, and improve audio signal encoding/decoding efficiency.

To resolve the foregoing problems, embodiments of this application provide the following technical solutions.

According to a first aspect, an embodiment of this application provides an audio encoding method. The method includes: obtaining a current frame of an audio signal, where the current frame includes a high frequency band signal and a low frequency band signal; obtaining a compatible layer encoding parameter of the current frame based on the high frequency band signal and the low frequency band signal; obtaining an enhancement layer encoding parameter of the current frame based on the high frequency band signal; and performing bitstream multiplexing on the compatible layer encoding parameter and the enhancement layer encoding parameter to obtain an encoded bitstream. In this embodiment of this application, all frequency domain ranges for encoding the audio signal may be included at a compatible layer, but only a high frequency domain range for encoding the audio signal is included at an enhancement layer. The compatible layer may be implemented by using an old audio encoding device, and the enhancement layer and the compatible layer may be implemented by using a new audio encoding device. Therefore, in this embodiment of this application, the new audio encoding device is compatible with the old audio encoding device. According to a device type of the audio encoding device, encoding may be performed at only the compatible layer, or at both the compatible layer and the enhancement layer. In this embodiment of this application, no new transcoding module needs to be added to the old audio encoding device. Therefore, upgrade costs of the audio encoding device are reduced, and audio signal encoding efficiency can be improved.

In an example implementation, the obtaining an enhancement layer encoding parameter of the current frame based on the high frequency band signal includes: obtaining signal type information of the high frequency band signal of the current frame; and encoding the high frequency band signal of the current frame when the signal type information of the high frequency band signal of the current frame indicates a preset signal type, to obtain the enhancement layer encoding parameter of the current frame. In this solution, the signal type information of the high frequency band signal of the current frame is obtained, and the signal type information may include a plurality of types of signal classification results based on signal types obtained through classification. The high frequency band signal of the current frame is encoded when the signal type information of the high frequency band signal of the current frame indicates the preset signal type, to obtain the enhancement layer encoding parameter of the current frame. For example, audio signals may be classified into N preset signal types, and N encoding modes may be set at the enhancement layer. One corresponding enhancement layer encoding mode may be executed for each preset signal type. Therefore, corresponding enhancement layer encoding modes are used for different signal types. This improves audio signal encoding efficiency.

In an example implementation, the preset signal type includes at least one of the following: a harmonic signal type, a tonal signal type, a white noise-like signal type, a transient signal type, or a fricative signal type. In this solution, the high frequency band signal of the current frame may have a plurality of preset signal types. For example, if the signal type of the high frequency band signal of the current frame is the harmonic signal type, that is, if the high frequency band signal of the current frame is a harmonic signal, an enhancement layer encoding mode 1 may be used to encode the harmonic signal at the enhancement layer. If the signal type of the high frequency band signal of the current frame is the tonal signal type, that is, if the high frequency band signal of the current frame includes a tonal component, an enhancement layer encoding mode 2 may be used to encode a tonal signal at the enhancement layer. If the signal type of the high frequency band signal of the current frame is the white noise-like signal type, that is, if the high frequency band signal of the current frame includes a white noise-like signal, an enhancement layer encoding mode 3 may be used to encode the white noise-like signal at the enhancement layer. If the signal type of the high frequency band signal of the current frame is the transient signal type, that is, if the high frequency band signal of the current frame includes a transient signal, an enhancement layer encoding mode 4 may be used to encode the transient signal at the enhancement layer. If the signal type of the high frequency band signal of the current frame is the fricative signal type, that is, if the high frequency band signal of the current frame includes a fricative signal, an enhancement layer encoding mode 5 may be used to encode the fricative signal at the enhancement layer. In this embodiment of this application, one corresponding enhancement layer encoding mode may be executed for each preset signal type. Therefore, corresponding enhancement layer encoding modes are used for different signal types. This improves audio signal encoding efficiency.

In an example implementation, the enhancement layer encoding parameter of the current frame further includes the signal type information of the high frequency band signal of the current frame. In this solution, the enhancement layer encoding parameter generated after the high frequency band signal of the current frame is encoded at the enhancement layer further includes the signal type information of the high frequency band signal of the current frame. Therefore, during bitstream multiplexing, the generated encoded bitstream may carry the signal type information of the high frequency band signal of the current frame, so that a decoding component may also use the signal type information to perform decoding at the enhancement layer based on different preset signal types. Therefore, an enhancement layer signal may be used to process a part of spectrum processed at the compatible layer, to improve performance of a final output signal.

In an example implementation, the obtaining an enhancement layer encoding parameter of the current frame based on the high frequency band signal includes: obtaining compatible layer encoding frequency band information; determining a to-be-encoded frequency band signal in the high frequency band signal of the current frame based on the compatible layer encoding frequency band information; and encoding the to-be-encoded frequency band signal to obtain the enhancement layer encoding parameter. In this solution, the compatible layer encoding frequency band information indicates frequency band information of the audio signal encoded at the compatible layer, that is, a specific frequency band or specific frequency bands on which compatible layer encoding is performed at the compatible layer can be determined based on the compatible layer encoding frequency band information. The to-be-encoded frequency band signal in the high frequency band signal of the current frame is determined based on the compatible layer encoding frequency band information. A high frequency band signal that needs to be encoded at the enhancement layer may be determined based on the compatible layer encoding frequency band information. Finally, the to-be-encoded frequency band signal that needs to be encoded at the enhancement layer is encoded, to obtain the enhancement layer encoding parameter. In this embodiment of this application, the compatible layer encoding frequency band information that is output at the compatible layer may be used to guide encoding at the enhancement layer on an encoder side, so that encoding at the enhancement layer and encoding at the compatible layer can be complementary. This improves audio signal encoding efficiency at the enhancement layer.

According to a second aspect, an embodiment of this application provides an audio decoding method. The method includes: obtaining an encoded bitstream; performing bitstream demultiplexing on the encoded bitstream to obtain a compatible layer encoding parameter of a current frame of an audio signal and an enhancement layer encoding parameter of the current frame; obtaining a compatible layer signal of the current frame based on the compatible layer encoding parameter, where the compatible layer signal includes a first high frequency band signal of the current frame and a first low frequency band signal of the current frame; obtaining an enhancement layer signal of the current frame based on the enhancement layer encoding parameter; adapting the first high frequency band signal of the current frame based on the enhancement layer encoding parameter or the enhancement layer signal of the current frame, to obtain a second high frequency band signal of the current frame; and obtaining an audio output signal of the current frame based on the enhancement layer signal of the current frame, the second high frequency band signal of the current frame, and the first low frequency band signal of the current frame. In this embodiment of this application, all frequency domain ranges for decoding the audio signal may be included at a compatible layer, but only a high frequency domain range for decoding the audio signal is included at an enhancement layer. The compatible layer may be implemented by using an old audio decoding device, and the enhancement layer and the compatible layer may be implemented by using a new audio decoding device. Therefore, in this embodiment of this application, the new audio decoding device is compatible with the old audio decoding device. According to a device type of the audio decoding device, decoding may be performed at only the compatible layer, or at both the compatible layer and the enhancement layer. In this embodiment of this application, no new transcoding module needs to be added to the old audio decoding device. Therefore, upgrade costs of the audio decoding device are reduced, and audio signal decoding efficiency can be improved.

In an example implementation, the obtaining an enhancement layer signal of the current frame based on the enhancement layer encoding parameter includes: obtaining signal type information based on the enhancement layer encoding parameter of the current frame; and decoding the enhancement layer encoding parameter of the current frame based on a preset signal type indicated by the signal type information, to obtain the enhancement layer signal of the current frame. In this solution, the encoded bitstream may carry the signal type information of the audio signal, and after performing bitstream demultiplexing on the encoded bitstream, a decoding component can obtain the signal type information of the enhancement layer encoding parameter of the current frame. The enhancement layer encoding parameter of the current frame is decoded based on the preset signal type indicated by the signal type information, to obtain the enhancement layer signal of the current frame. For example, audio signals may be classified into N preset signal types, and N decoding modes may be set at the enhancement layer. One corresponding enhancement layer decoding mode may be executed for each preset signal type. Therefore, corresponding enhancement layer decoding modes are used for different signal types. This improves audio signal decoding efficiency. In this embodiment of this application, the decoding component selects appropriate enhancement layer decoding for processing based on the signal type information. Therefore, the enhancement layer signal may be used to process a part of spectrum processed at the compatible layer, to improve performance of a final output signal.

In an example implementation, the adapting the first high frequency band signal of the current frame based on the enhancement layer encoding parameter or the enhancement layer signal of the current frame, to obtain a second high frequency band signal of the current frame includes: obtaining a compatible layer high frequency band adjustment parameter based on the enhancement layer encoding parameter or the enhancement layer signal of the current frame and the first high frequency band signal of the current frame; and adapting the first high frequency band signal of the current frame by using the compatible layer high frequency band adjustment parameter, to obtain the second high frequency band signal of the current frame. In this solution, the compatible layer high frequency band adjustment parameter may be obtained based on the enhancement layer encoding parameter or the enhancement layer signal and the first high frequency band signal at the compatible layer. The compatible layer high frequency band adjustment parameter (which may be referred to as an adjustment parameter for short in the following embodiments) is an adjustment parameter used to adjust a high frequency part of the compatible layer signal. For example, the compatible layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated based on the enhancement layer signal of the current frame and the first high frequency band signal of the current frame, and the first high frequency band signal of the current frame is adapted by using the adjustment parameter, to obtain the second high frequency band signal of the current frame. Adapting the first high frequency band signal by using the adjustment parameter can obtain a better compatible layer high frequency band signal, so that a better audio output signal is output, and performance of the audio output signal is improved.

In an example implementation, the obtaining a compatible layer high frequency band adjustment parameter based on the enhancement layer encoding parameter or the enhancement layer signal of the current frame and the first high frequency band signal of the current frame includes: obtaining envelope information corresponding to the enhancement layer encoding parameter or the enhancement layer signal of the current frame, and obtaining envelope information of the first high frequency band signal of the current frame; and obtaining the compatible layer high frequency band adjustment parameter based on the envelope information corresponding to the enhancement layer encoding parameter or the enhancement layer signal and the envelope information of the first high frequency band signal. In this solution, compatible layer output information may be directly obtained through parsing from the compatible layer, the output information and the enhancement layer signal are used for joint calculation to obtain a high frequency band spectrum adjustment parameter of the compatible layer signal, and a high frequency band signal of the compatible layer signal is adjusted by using the adjustment parameter and is combined with an enhancement layer output signal to obtain a final output signal. The adjustment parameter may be calculated in a plurality of implementations. The adjustment parameter may be calculated based on the envelope information corresponding to the enhancement layer encoding parameter or the enhancement layer signal and the envelope information of the first high frequency band signal. The envelope information corresponding to the enhancement layer encoding parameter may be envelope information that is of a high frequency band signal and that is calculated based on the enhancement layer encoding parameter, or the envelope information corresponding to the enhancement layer signal may be an amplitude of the enhancement layer signal, and the envelope information of the first high frequency band signal may be an amplitude of the high frequency band signal in the compatible layer signal. The compatible layer high frequency band adjustment parameter may be calculated based on the envelope information corresponding to the enhancement layer encoding parameter or the enhancement layer signal and the envelope information of the first high frequency band signal.

In an example implementation, the adapting the first high frequency band signal of the current frame based on the enhancement layer encoding parameter or the enhancement layer signal of the current frame, to obtain a second high frequency band signal of the current frame includes: selecting an enhancement layer high frequency band spectrum signal of the current frame from the enhancement layer signal of the current frame according to a preset high frequency band spectrum selection rule; and combining the enhancement layer high frequency band spectrum signal and the first high frequency band signal of the current frame, to obtain the second high frequency band signal of the current frame. In this solution, the high frequency band spectrum selection rule may be preset. The high frequency band spectrum selection rule may be used to indicate to select the high frequency band spectrum signal from the enhancement layer signal. For example, the high frequency band spectrum selection rule specifies one or more selected frequency bands, or the high frequency band spectrum selection rule indicates a frequency band that needs to be selected from the enhancement layer signal. The enhancement layer high frequency band spectrum signal of the current frame is selected from the enhancement layer signal of the current frame according to the preset high frequency band spectrum selection rule. The enhancement layer high frequency band spectrum signal is a selected high frequency band spectrum signal in the enhancement layer signal. The enhancement layer high frequency band spectrum signal is combined with the first high frequency band signal of the current frame to obtain the second high frequency band signal of the current frame. In this embodiment of this application, the high frequency band spectrum selection rule is set, so that some high frequency band signals may be selected from the enhancement layer signal and combined with the first high frequency band signal at the compatible layer, to generate the second high frequency band signal at the compatible layer. Therefore, in this embodiment of this application, a better compatible layer high frequency band signal can be obtained, so that a better audio output signal is output, and performance of the audio output signal is improved.

In an example implementation, the selecting an enhancement layer high frequency band spectrum signal of the current frame from the enhancement layer signal of the current frame according to a preset high frequency band spectrum selection rule includes: obtaining a compatible layer decoded signal and a compatible layer bandwidth extension signal that are included in the first high frequency band signal of the current frame; and determining, as the enhancement layer high frequency band spectrum signal of the current frame, a signal that is in the enhancement layer signal of the current frame and that corresponds to the compatible layer bandwidth extension signal. In this solution, the compatible layer decoded signal and the compatible layer bandwidth extension signal that are included in the first high frequency band signal may be determined. The compatible layer decoded signal is a signal obtained by the decoding component by decoding the compatible layer encoding parameter at the compatible layer, and the compatible layer bandwidth extension signal is a signal obtained by the decoding component through bandwidth extension at the compatible layer. For example, a low frequency band signal is extended to a high frequency band, to obtain the compatible layer bandwidth extension signal. In this embodiment of this application, the decoding component may select the enhancement layer high frequency band spectrum signal of the current frame from the enhancement layer signal of the current frame based on the compatible layer bandwidth extension signal. In other words, a signal that is in the enhancement layer signal and that corresponds to the compatible layer decoded signal at the compatible layer is not selected. In this way, the enhancement layer high frequency band spectrum signal is a spectrum signal selected from the enhancement layer signal, and after the compatible layer signal is adjusted by using the enhancement layer high frequency band spectrum signal and an adjusted signal is combined with an enhancement layer output, a final output signal is obtained. A better compatible layer high frequency band signal can be obtained, so that a better audio output signal is output, and performance of the audio output signal is improved.

In an example implementation, the adapting the first high frequency band signal of the current frame based on the enhancement layer encoding parameter or the enhancement layer signal of the current frame, to obtain a second high frequency band signal of the current frame includes: replacing the first high frequency band signal of the current frame with the enhancement layer signal of the current frame, to obtain the second high frequency band signal of the current frame. In this solution, an adaptation implementation may be direct replacement. The decoding component may replace the first high frequency band signal of the current frame with the enhancement layer signal of the current frame. In other words, the first low frequency band signal at the compatible layer remains unchanged, the first high frequency band signal at the compatible layer may be replaced with the enhancement layer signal of the current frame, and the enhancement layer signal of the current frame may be used as the adapted second high frequency band signal. Therefore, in this embodiment of this application, a better compatible layer high frequency band signal can be obtained, so that a better audio output signal is output, and performance of the audio output signal is improved.

In an example implementation, the replacing the first high frequency band signal of the current frame with the enhancement layer signal of the current frame, to obtain the second high frequency band signal of the current frame includes: obtaining an enhancement layer high frequency band adjustment parameter based on the enhancement layer encoding parameter or the enhancement layer signal of the current frame and the first high frequency band signal of the current frame; adapting the enhancement layer signal of the current frame by using the enhancement layer high frequency band adjustment parameter, to obtain an adapted enhancement layer signal; and replacing the first high frequency band signal of the current frame with the adapted enhancement layer signal, to obtain the second high frequency band signal of the current frame. In this solution, the enhancement layer high frequency band adjustment parameter may be obtained based on the enhancement layer signal and the first high frequency band signal at the compatible layer. The enhancement layer high frequency band adjustment parameter (which may be referred to as an adjustment parameter for short in the following embodiments) is an adjustment parameter used to adjust the enhancement layer signal. The enhancement layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated by using the enhancement layer signal of the current frame and the first high frequency band signal of the current frame, and the enhancement layer signal of the current frame is adapted by using the adjustment parameter, to obtain the adapted enhancement layer signal. The enhancement layer signal of the current frame is adapted by using the adjustment parameter, and then the first high frequency band signal of the current frame is replaced with the adapted enhancement layer signal. In this way, a better compatible layer high frequency band signal can be obtained, so that a better audio output signal is output, and performance of the audio output signal is improved.

In an example implementation, the replacing the first high frequency band signal of the current frame with the enhancement layer signal of the current frame, to obtain the second high frequency band signal of the current frame includes: obtaining an enhancement layer high frequency band adjustment parameter based on the enhancement layer encoding parameter or the enhancement layer signal of the current frame and the first high frequency band signal of the current frame; replacing the first high frequency band signal of the current frame with the enhancement layer signal of the current frame, to obtain a first high frequency band signal generated after the replacement; and adapting, by using the enhancement layer high frequency band adjustment parameter, the first high frequency band signal generated after the replacement, to obtain the second high frequency band signal of the current frame. In this solution, the enhancement layer high frequency band adjustment parameter may be obtained based on the enhancement layer signal and the first high frequency band signal at the compatible layer. The enhancement layer high frequency band adjustment parameter (which may be referred to as an adjustment parameter for short in the following embodiments) is an adjustment parameter used to adjust the enhancement layer signal. The enhancement layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated by using the enhancement layer signal of the current frame and the first high frequency band signal of the current frame, and after the first high frequency band signal generated after the replacement is obtained, the first high frequency band signal generated after the replacement is adapted by using the adjustment parameter, to obtain the second high frequency band signal of the current frame. Adapting, by using the adjustment parameter, the first high frequency band signal generated after the replacement can obtain a better compatible layer high frequency band signal, so that a better audio output signal is output, and performance of the audio output signal is improved.

In an example implementation, the replacing the first high frequency band signal of the current frame with the enhancement layer signal of the current frame, to obtain the second high frequency band signal of the current frame includes: performing spectrum component comparison selection on the enhancement layer signal of the current frame and the first high frequency band signal of the current frame, to select a first enhancement layer sub-signal from the enhancement layer signal of the current frame; and replacing, with the first enhancement layer sub-signal, a signal that is in the first high frequency band signal of the current frame and that has a same spectrum as the first enhancement layer sub-signal, to obtain the second high frequency band signal of the current frame. In this solution, a spectrum component corresponding to the enhancement layer signal may be compared with a spectrum component corresponding to the first high frequency band signal in the compatible layer signal. After the spectrum component comparison is completed, the first enhancement layer sub-signal is selected from the enhancement layer signal of the current frame. Finally, the signal that is in the first high frequency band signal of the current frame and that has the same spectrum as the first enhancement layer sub-signal is replaced with the selected first enhancement layer sub-signal, to obtain the second high frequency band signal of the current frame. For example, the decoding component performs the foregoing spectrum component comparison selection. According to a comparison result, some spectrum components in the enhancement layer signal are used to replace corresponding spectrum components in the compatible layer signal, to obtain spectrum components in a final output signal. In addition, the other spectrum components in the enhancement layer signal are discarded, and all spectrum components of the final output signal are obtained by combining the spectrum components obtained after the replacement in the compatible layer signal with the other spectrum components in the compatible layer signal.

In an example implementation, the obtaining an enhancement layer signal of the current frame based on the enhancement layer encoding parameter includes: determining a to-be-decoded enhancement layer high frequency band signal in the enhancement layer encoding parameter based on the enhancement layer encoding parameter and the compatible layer encoding parameter; and decoding the to-be-decoded enhancement layer high frequency band signal in the enhancement layer encoding parameter, to obtain the enhancement layer signal of the current frame. In this solution, the enhancement layer encoding parameter and the compatible layer encoding parameter may be obtained. The decoding component determines, based on the enhancement layer encoding parameter and the compatible layer encoding parameter, a high frequency band signal that needs to be decoded at the enhancement layer in the enhancement layer encoding parameter (namely, the to-be-decoded enhancement layer high frequency band signal), and then decodes the high frequency band signal that needs to be decoded at the enhancement layer. A high frequency band signal that is in the enhancement layer encoding parameter and that is not determined as a to-be-decoded signal may be discarded. Therefore, only the to-be-decoded enhancement layer high frequency band signal needs to be decoded, and not all of the enhancement layer encoding parameter needs to be decoded. This improves audio signal decoding efficiency at the enhancement layer.

In an example implementation, the adapting the first high frequency band signal of the current frame based on the enhancement layer encoding parameter or the enhancement layer signal of the current frame, to obtain a second high frequency band signal of the current frame includes: obtaining a compatible layer decoded signal and a compatible layer bandwidth extension signal in the compatible layer signal of the current frame; and combining the compatible layer bandwidth extension signal and the enhancement layer signal of the current frame, to obtain the second high frequency band signal of the current frame. In this solution, the compatible layer decoded signal and the compatible layer bandwidth extension signal that are included in the compatible layer signal may be determined. The compatible layer decoded signal is a signal obtained by the decoding component by decoding the compatible layer encoding parameter at the compatible layer, and the compatible layer bandwidth extension signal is a signal obtained by the decoding component through bandwidth extension at the compatible layer. For example, a low frequency band signal is extended to a high frequency band, to obtain the compatible layer bandwidth extension signal. In this embodiment of this application, the decoding component may combine the compatible layer bandwidth extension signal and the enhancement layer signal of the current frame. In other words, the compatible layer decoded signal in the first high frequency band signal is not combined with the enhancement layer signal, and the decoding component combines only the compatible layer bandwidth extension signal with the enhancement layer signal of the current frame. After the second high frequency band signal of the current frame is obtained, and the second high frequency band signal, the enhancement layer signal, and the first low frequency band signal are combined, a final output signal is obtained. A better compatible layer high frequency band signal can be obtained, so that a better audio output signal is output, and performance of the audio output signal is improved.

In an example implementation, a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY]; and FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal; or FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal. In this solution, in this embodiment, the decoding component may learn which spectrums in the compatible layer signal are obtained through encoding and decoding, and which spectrums in the compatible layer signal are obtained through bandwidth extension. The final output signal includes the spectrums of an encoding and decoding part in the compatible layer signal, and spectrums of a bandwidth extension part may be obtained by combining corresponding spectrum components in the enhancement layer signal and the compatible layer signal.

In an example implementation, after the obtaining an audio output signal of the current frame based on the enhancement layer signal of the current frame, the second high frequency band signal of the current frame, and the first low frequency band signal of the current frame, the method further includes: post-processing the audio output signal of the current frame. In this solution, after the audio output signal of the current frame is obtained, the audio output signal may further be post-processed, so that a post-processing gain can be achieved.

In an example implementation, before the obtaining an audio output signal of the current frame based on the enhancement layer signal of the current frame, the second high frequency band signal of the current frame, and the first low frequency band signal of the current frame, the method further includes: obtaining a post-processing parameter based on the compatible layer signal; and post-processing the enhancement layer signal by using the post-processing parameter, to obtain a post-processed enhancement layer signal. In this solution, before the audio output signal of the current frame is obtained, the post-processing parameter may further be obtained based on the compatible layer signal. The post-processing parameter is a parameter required for post-processing. Corresponding post-processing parameters need to be obtained based on different types of post-processing. The enhancement layer signal is post-processed by using the post-processing parameter, and after the post-processing is completed, the post-processed enhancement layer signal, the second high frequency band signal of the current frame, and the first low frequency band signal of the current frame may be combined, to obtain the audio output signal. In this embodiment of this application, the enhancement layer signal may be post-processed, so that a post-processing gain can be achieved.

According to a third aspect, an embodiment of this application further provides an audio encoding device. The audio encoding device includes at least one processor, and the at least one processor is configured to: be coupled to a memory, and read and execute instructions in the memory, to implement the method according to any one of the possible implementations of the first aspect.

In an example implementation, the audio encoding device further includes the memory.

According to a fourth aspect, an embodiment of this application further provides an audio decoding device. The audio decoding device includes at least one processor, and the at least one processor is configured to: be coupled to a memory, and read and execute instructions in the memory, to implement the method according to any one of the possible implementations of the second aspect.

In an example implementation, the audio decoding device further includes the memory.

According to a fifth aspect, an embodiment of this application further provides an audio encoding device. The audio encoding device includes a compatible layer encoder, an enhancement layer encoder, and a bitstream multiplexer. The compatible layer encoder is configured to: obtain a current frame of an audio signal, where the current frame includes a high frequency band signal and a low frequency band signal; and obtain a compatible layer encoding parameter of the current frame based on the high frequency band signal and the low frequency band signal. The enhancement layer encoder is configured to: obtain the current frame of the audio signal, where the current frame includes the high frequency band signal and the low frequency band signal; and obtain an enhancement layer encoding parameter of the current frame based on the high frequency band signal. The bitstream multiplexer is configured to perform bitstream multiplexing on the compatible layer encoding parameter and the enhancement layer encoding parameter to obtain an encoded bitstream.

In some embodiments of this application, the enhancement layer encoder is configured to: obtain signal type information of the high frequency band signal of the current frame; and encode the high frequency band signal of the current frame when the signal type information of the high frequency band signal of the current frame indicates a preset signal type, to obtain the enhancement layer encoding parameter of the current frame.

In some embodiments of this application, the preset signal type includes at least one of the following: a harmonic signal type, a tonal signal type, a white noise-like signal type, a transient signal type, or a fricative signal type.

In some embodiments of this application, the enhancement layer encoding parameter of the current frame further includes the signal type information of the high frequency band signal of the current frame.

In some embodiments of this application, the enhancement layer encoder is configured to: obtain compatible layer encoding frequency band information; determine a to-be-encoded frequency band signal in the high frequency band signal of the current frame based on the compatible layer encoding frequency band information; and encode the to-be-encoded frequency band signal to obtain the enhancement layer encoding parameter.

In the fifth aspect of this application, the components of the audio encoding device may further perform the steps described in the first aspect and the possible implementations. For details, refer to the foregoing descriptions in the first aspect and the possible implementations.

According to a sixth aspect, an embodiment of this application further provides an audio decoding device. The audio decoding device includes a bitstream demultiplexer, a compatible layer decoder, an enhancement layer decoder, an adaptation processor, and a combiner. The bitstream demultiplexer is configured to: obtain an encoded bitstream; and perform bitstream demultiplexing on the encoded bitstream to obtain a compatible layer encoding parameter of a current frame of an audio signal and an enhancement layer encoding parameter of the current frame. The compatible layer decoder is configured to obtain a compatible layer signal of the current frame based on the compatible layer encoding parameter, where the compatible layer signal includes a first high frequency band signal of the current frame and a first low frequency band signal of the current frame. The enhancement layer decoder is configured to obtain an enhancement layer signal of the current frame based on the enhancement layer encoding parameter. The adaptation processor is configured to adapt the first high frequency band signal of the current frame based on the enhancement layer encoding parameter or the enhancement layer signal of the current frame, to obtain a second high frequency band signal of the current frame. The combiner is configured to obtain an audio output signal of the current frame based on the enhancement layer signal of the current frame, the second high frequency band signal of the current frame, and the first low frequency band signal of the current frame.

In some embodiments of this application, the enhancement layer decoder is configured to: obtain signal type information based on the enhancement layer encoding parameter of the current frame; and decode the enhancement layer encoding parameter of the current frame based on a preset signal type indicated by the signal type information, to obtain the enhancement layer signal of the current frame.

In some embodiments of this application, the adaptation processor is configured to: obtain a compatible layer high frequency band adjustment parameter based on the enhancement layer encoding parameter or the enhancement layer signal of the current frame and the first high frequency band signal of the current frame; and adapt the first high frequency band signal of the current frame by using the compatible layer high frequency band adjustment parameter, to obtain the second high frequency band signal of the current frame.

In some embodiments of this application, the adaptation processor is configured to: obtain envelope information corresponding to the enhancement layer encoding parameter or the enhancement layer signal of the current frame, and obtain envelope information of the first high frequency band signal of the current frame; and obtain the compatible layer high frequency band adjustment parameter based on the envelope information corresponding to the enhancement layer encoding parameter or the enhancement layer signal and the envelope information of the first high frequency band signal.

In some embodiments of this application, the adaptation processor is configured to: select an enhancement layer high frequency band spectrum signal of the current frame from the enhancement layer signal of the current frame according to a preset high frequency band spectrum selection rule; and combine the enhancement layer high frequency band spectrum signal and the first high frequency band signal of the current frame, to obtain the second high frequency band signal of the current frame.

In some embodiments of this application, the adaptation processor is configured to: obtain a compatible layer decoded signal and a compatible layer bandwidth extension signal that are included in the first high frequency band signal of the current frame; and determine, as the enhancement layer high frequency band spectrum signal of the current frame, a signal that is in the enhancement layer signal of the current frame and that corresponds to the compatible layer bandwidth extension signal.

In some embodiments of this application, the adaptation processor is configured to replace the first high frequency band signal of the current frame with the enhancement layer signal of the current frame, to obtain the second high frequency band signal of the current frame.

In some embodiments of this application, the adaptation processor is configured to: obtain an enhancement layer high frequency band adjustment parameter based on the enhancement layer encoding parameter or the enhancement layer signal of the current frame and the first high frequency band signal of the current frame; adapt the enhancement layer signal of the current frame by using the enhancement layer high frequency band adjustment parameter, to obtain an adapted enhancement layer signal; and replace the first high frequency band signal of the current frame with the adapted enhancement layer signal, to obtain the second high frequency band signal of the current frame.

In some embodiments of this application, the adaptation processor is configured to: obtain an enhancement layer high frequency band adjustment parameter based on the enhancement layer encoding parameter or the enhancement layer signal of the current frame and the first high frequency band signal of the current frame; replace the first high frequency band signal of the current frame with the enhancement layer signal of the current frame, to obtain a first high frequency band signal generated after the replacement; and adapt, by using the enhancement layer high frequency band adjustment parameter, the first high frequency band signal generated after the replacement, to obtain the second high frequency band signal of the current frame.

In some embodiments of this application, the adaptation processor is configured to: perform spectrum component comparison selection on the enhancement layer signal of the current frame and the first high frequency band signal of the current frame, to select a first enhancement layer sub-signal from the enhancement layer signal of the current frame; and replace, with the first enhancement layer sub-signal, a signal that is in the first high frequency band signal of the current frame and that has a same spectrum as the first enhancement layer sub-signal, to obtain the second high frequency band signal of the current frame.

In some embodiments of this application, the enhancement layer decoder is configured to: determine a to-be-decoded enhancement layer high frequency band signal in the enhancement layer encoding parameter based on the enhancement layer encoding parameter and the compatible layer encoding parameter; and decode the to-be-decoded enhancement layer high frequency band signal in the enhancement layer encoding parameter, to obtain the enhancement layer signal of the current frame.

In some embodiments of this application, the adaptation processor is configured to: obtain a compatible layer decoded signal and a compatible layer bandwidth extension signal in the compatible layer signal of the current frame; and combine the compatible layer bandwidth extension signal and the enhancement layer signal of the current frame, to obtain the second high frequency band signal of the current frame.

In some embodiments of this application, a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY].

FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

Alternatively, FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

In some embodiments of this application, the adaptation processor is further configured to post-process the audio output signal of the current frame after the combiner obtains the audio output signal of the current frame based on the enhancement layer signal of the current frame, the second high frequency band signal of the current frame, and the first low frequency band signal of the current frame.

In some embodiments of this application, the adaptation processor is further configured to: before the combiner obtains the audio output signal of the current frame based on the enhancement layer signal of the current frame, the second high frequency band signal of the current frame, and the first low frequency band signal of the current frame, obtain a post-processing parameter based on the compatible layer signal; and post-process the enhancement layer signal by using the post-processing parameter, to obtain a post-processed enhancement layer signal.

In the sixth aspect of this application, the components of the audio decoding device may further perform the steps described in the second aspect and the possible implementations. For details, refer to the foregoing descriptions in the second aspect and the possible implementations.

According to a seventh aspect, an embodiment of this application further provides an audio encoding device. The audio encoding device may include: an obtaining module, configured to obtain a current frame of an audio signal, where the current frame includes a high frequency band signal and a low frequency band signal; a compatible layer encoding module, configured to obtain a compatible layer encoding parameter of the current frame based on the high frequency band signal and the low frequency band signal; an enhancement layer encoding module, configured to obtain an enhancement layer encoding parameter of the current frame based on the high frequency band signal; and a multiplexing module, configured to perform bitstream multiplexing on the compatible layer encoding parameter and the enhancement layer encoding parameter to obtain an encoded bitstream.

In some embodiments of this application, the enhancement layer encoding module is configured to: obtain signal type information of the high frequency band signal of the current frame; and encode the high frequency band signal of the current frame when the signal type information of the high frequency band signal of the current frame indicates a preset signal type, to obtain the enhancement layer encoding parameter of the current frame.

In some embodiments of this application, the preset signal type includes at least one of the following: a harmonic signal type, a tonal signal type, a white noise-like signal type, a transient signal type, or a fricative signal type.

In some embodiments of this application, the enhancement layer encoding parameter of the current frame further includes the signal type information of the high frequency band signal of the current frame.

In some embodiments of this application, the enhancement layer encoding module is configured to: obtain compatible layer encoding frequency band information; determine a to-be-encoded frequency band signal in the high frequency band signal of the current frame based on the compatible layer encoding frequency band information; and encode the to-be-encoded frequency band signal to obtain the enhancement layer encoding parameter.

According to an eighth aspect, an embodiment of this application further provides an audio decoding device. The audio decoding device may include: an obtaining module, configured to obtain an encoded bitstream; a demultiplexing module, configured to perform bitstream demultiplexing on the encoded bitstream to obtain a compatible layer encoding parameter of a current frame of an audio signal and an enhancement layer encoding parameter of the current frame; a compatible layer decoding module, configured to obtain a compatible layer signal of the current frame based on the compatible layer encoding parameter, where the compatible layer signal includes a first high frequency band signal of the current frame and a first low frequency band signal of the current frame; an enhancement layer decoding module, configured to obtain an enhancement layer signal of the current frame based on the enhancement layer encoding parameter; an adaptation module, configured to adapt the first high frequency band signal of the current frame based on the enhancement layer encoding parameter or the enhancement layer signal of the current frame, to obtain a second high frequency band signal of the current frame; and a combination module, configured to obtain an audio output signal of the current frame based on the enhancement layer signal of the current frame, the second high frequency band signal of the current frame, and the first low frequency band signal of the current frame.

In some embodiments of this application, the enhancement layer decoding module is configured to: obtain signal type information based on the enhancement layer encoding parameter of the current frame; and decode the enhancement layer encoding parameter of the current frame based on a preset signal type indicated by the signal type information, to obtain the enhancement layer signal of the current frame.

In some embodiments of this application, the adaptation module is configured to: obtain a compatible layer high frequency band adjustment parameter based on the enhancement layer encoding parameter or the enhancement layer signal of the current frame and the first high frequency band signal of the current frame; and adapt the first high frequency band signal of the current frame by using the compatible layer high frequency band adjustment parameter, to obtain the second high frequency band signal of the current frame.

In some embodiments of this application, the adaptation module is configured to: obtain envelope information corresponding to the enhancement layer encoding parameter or the enhancement layer signal of the current frame, and obtain envelope information of the first high frequency band signal of the current frame; and obtain the compatible layer high frequency band adjustment parameter based on the envelope information corresponding to the enhancement layer encoding parameter or the enhancement layer signal and the envelope information of the first high frequency band signal.

In some embodiments of this application, the adaptation module is configured to: select an enhancement layer high frequency band spectrum signal of the current frame from the enhancement layer signal of the current frame according to a preset high frequency band spectrum selection rule; and combine the enhancement layer high frequency band spectrum signal and the first high frequency band signal of the current frame, to obtain the second high frequency band signal of the current frame.

In some embodiments of this application, the adaptation module is configured to: obtain a compatible layer decoded signal and a compatible layer bandwidth extension signal that are included in the first high frequency band signal of the current frame; and determine, as the enhancement layer high frequency band spectrum signal of the current frame, a signal that is in the enhancement layer signal of the current frame and that corresponds to the compatible layer bandwidth extension signal.

In some embodiments of this application, the adaptation module is configured to replace the first high frequency band signal of the current frame with the enhancement layer signal of the current frame, to obtain the second high frequency band signal of the current frame.

In some embodiments of this application, the adaptation module is configured to: obtain an enhancement layer high frequency band adjustment parameter based on the enhancement layer encoding parameter or the enhancement layer signal of the current frame and the first high frequency band signal of the current frame; adapt the enhancement layer signal of the current frame by using the enhancement layer high frequency band adjustment parameter, to obtain an adapted enhancement layer signal; and replace the first high frequency band signal of the current frame with the adapted enhancement layer signal, to obtain the second high frequency band signal of the current frame.

In some embodiments of this application, the adaptation module is configured to: obtain an enhancement layer high frequency band adjustment parameter based on the enhancement layer encoding parameter or the enhancement layer signal of the current frame and the first high frequency band signal of the current frame; replace the first high frequency band signal of the current frame with the enhancement layer signal of the current frame, to obtain a first high frequency band signal generated after the replacement; and adapt, by using the enhancement layer high frequency band adjustment parameter, the first high frequency band signal generated after the replacement, to obtain the second high frequency band signal of the current frame.

In some embodiments of this application, the adaptation module is configured to: perform spectrum component comparison selection on the enhancement layer signal of the current frame and the first high frequency band signal of the current frame, to select a first enhancement layer sub-signal from the enhancement layer signal of the current frame; and replace, with the first enhancement layer sub-signal, a signal that is in the first high frequency band signal of the current frame and that has a same spectrum as the first enhancement layer sub-signal, to obtain the second high frequency band signal of the current frame.

In some embodiments of this application, the enhancement layer decoding module is configured to: determine a to-be-decoded enhancement layer high frequency band signal in the enhancement layer encoding parameter based on the enhancement layer encoding parameter and the compatible layer encoding parameter; and decode the to-be-decoded enhancement layer high frequency band signal in the enhancement layer encoding parameter, to obtain the enhancement layer signal of the current frame.

In some embodiments of this application, the adaptation module is configured to: obtain a compatible layer decoded signal and a compatible layer bandwidth extension signal in the compatible layer signal of the current frame; and combine the compatible layer bandwidth extension signal and the enhancement layer signal of the current frame, to obtain the second high frequency band signal of the current frame.

In some embodiments of this application, a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY].

FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

Alternatively, FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

In some embodiments of this application, the audio decoding device may further include a post-processing module, configured to post-process the audio output signal of the current frame after the combination module obtains the audio output signal of the current frame based on the enhancement layer signal of the current frame, the second high frequency band signal of the current frame, and the first low frequency band signal of the current frame.

In some embodiments of this application, the audio decoding device may further include a post-processing module, configured to: before the combination module obtains the audio output signal of the current frame based on the enhancement layer signal of the current frame, the second high frequency band signal of the current frame, and the first low frequency band signal of the current frame, obtain a post-processing parameter based on the compatible layer signal; and post-process the enhancement layer signal by using the post-processing parameter, to obtain a post-processed enhancement layer signal.

According to a ninth aspect, an embodiment of this application provides a computer-readable storage medium. The computer-readable storage medium stores instructions, and when the instructions are run on a computer, the computer is enabled to perform the method according to the first aspect or the second aspect.

According to a tenth aspect, an embodiment of this application provides a computer program product including instructions. When the computer program product runs on a computer, the computer is enabled to perform the method according to the first aspect or the second aspect.

According to an eleventh aspect, an embodiment of this application provides a communications apparatus. The communications apparatus may include an entity such as an audio encoding/decoding device or a chip. The communications apparatus includes a processor, and optionally, further includes a memory. The memory is configured to store instructions. The processor is configured to execute the instructions in the memory, so that the communications apparatus performs the method according to any one of the first aspect or the second aspect.

According to a twelfth aspect, this application provides a chip system. The chip system includes a processor, configured to support an audio encoding/decoding device in implementing a function in the foregoing aspect, for example, sending or processing data and/or information in the foregoing method. In an example design, the chip system further includes a memory. The memory is configured to store program instructions and data necessary for the audio encoding/decoding device. The chip system may include a chip, or may include a chip and another discrete component.

### BRIEF DESCRIPTION OF DRAWINGS

FIG. 1 is a schematic diagram of a structure of an audio encoding and decoding system according to an embodiment of this application;

FIG. 2 is a schematic flowchart of an audio encoding method according to an embodiment of this application;

FIG. 3 is a schematic flowchart of an audio decoding method according to an embodiment of this application;

FIG. 4 is a schematic diagram of a mobile terminal according to an embodiment of this application;

FIG. 5 is a schematic diagram of a network element according to an embodiment of this application;

FIG. 6 is a schematic flowchart of an audio encoding method according to an embodiment of this application;

FIG. 7a is a schematic diagram of a spectrum of an original signal according to an embodiment of this application;

FIG. 7b is a schematic diagram of a spectrum of a compatible layer encoded signal according to an embodiment of this application;

FIG. 7c is a schematic diagram of a spectrum of an enhancement layer encoded signal according to an embodiment of this application;

FIG. 7d is a schematic diagram of a spectrum of an audio output signal according to an embodiment of this application;

FIG. 8 is a schematic diagram of an output spectrum obtained after an enhancement layer encoding parameter and a compatible layer encoding parameter are combined according to an embodiment of this application;

FIG. 9 is a schematic diagram of a composition structure of an audio encoding device according to an embodiment of this application;

FIG. 10 is a schematic diagram of a composition structure of an audio decoding device according to an embodiment of this application;

FIG. 11 is a schematic diagram of a composition structure of another audio encoding device according to an embodiment of this application;

FIG. 12 is a schematic diagram of a composition structure of another audio decoding device according to an embodiment of this application;

FIG. 13 is a schematic diagram of a composition structure of another audio encoding device according to an embodiment of this application; and

FIG. 14 is a schematic diagram of a composition structure of another audio decoding device according to an embodiment of this application.

### DESCRIPTION OF EMBODIMENTS

Embodiments of this application provide an audio encoding method and device and an audio decoding method and device, to implement compatibility between a new encoding/decoding device and an old encoding/decoding device, and improve audio signal encoding/decoding efficiency.

The following describes embodiments of this application with reference to accompanying drawings.

In the specification, claims, and the accompanying drawings of this application, the terms “first”, “second”, and the like are intended to distinguish similar objects but do not necessarily indicate a specific order or sequence. It should be understood that the terms used in such a way are interchangeable in proper circumstances, which is merely a discrimination manner that is used when objects having a same attribute are described in embodiments of this application. In addition, the terms “include”, “have”, and any other variations thereof are intended to cover the non-exclusive inclusion, so that a process, method, system, product, or device that includes a series of units is not limited to those units, but may include other units not expressly listed or inherent to such a process, method, product, or device.

The audio signal in embodiments of this application is an input signal in an audio encoding device, and the audio signal may include a plurality of frames. For example, a current frame may be a specific frame in the audio signal. In embodiments of this application, encoding/decoding of the current frame of the audio signal is used as an example for description.

A previous frame or a next frame of the current frame in the audio signal may be correspondingly encoded/decoded in a manner of encoding/decoding the current frame of the audio signal. A process of encoding/decoding the previous frame or the next frame of the current frame in the audio signal is not described one by one. In addition, the audio signal in embodiments of this application may be a mono audio signal, or may be a stereo signal. The stereo signal may be an original stereo signal, or may be a stereo signal including two signals (a left-channel signal and a right-channel signal) included in a multi-channel signal, or may be a stereo signal including two signals generated from at least three signals included in a multi-channel signal. This is not limited in embodiments of this application.

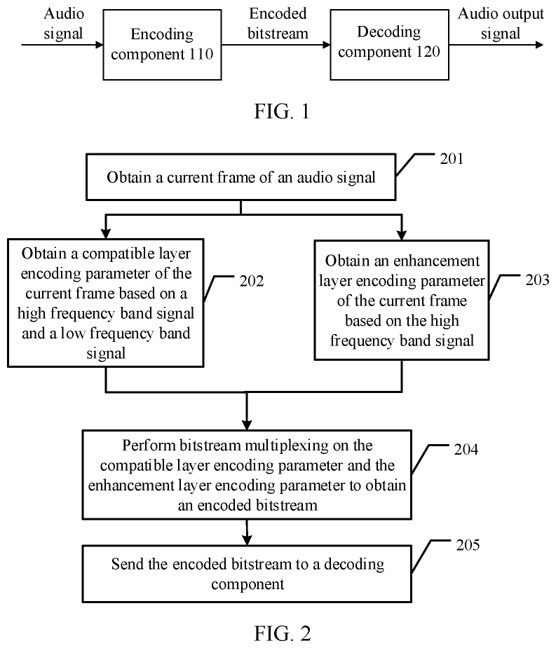

FIG. 1 is a schematic diagram of a structure of an audio encoding and decoding system according to an example embodiment of this application. The audio encoding and decoding system includes an encoding component 110 and a decoding component 120.

In this embodiment of this application, the audio encoding and decoding system may include a compatible layer and an enhancement layer. For example, in the audio encoding and decoding system, an encoding component and a decoding component may be disposed for the compatible layer, and an encoding component and a decoding component may be disposed for the enhancement layer. The compatible layer and the enhancement layer are two layers that are classified based on a spectrum range for processing an audio signal. Specifically, all frequency domain ranges for processing the audio signal may be included at the compatible layer, and only a high frequency domain range for processing the audio signal is included at the enhancement layer. The compatible layer may be implemented by using an old encoding/decoding component, and the enhancement layer and the compatible layer may be implemented by using a new encoding/decoding component. Therefore, in the audio encoding and decoding system provided in this embodiment of this application, the new encoding/decoding component is compatible with the old encoding/decoding component. According to a device type of the encoding/decoding component, encoding/decoding may be performed at only the compatible layer, or at both the compatible layer and the enhancement layer. This is not limited herein.

For example, in this embodiment of this application, the new encoding/decoding component needs to be fully backward-compatible with the old encoding/decoding component, that is, an audio encoded/decoded compatible layer signal includes all spectrum components of an input signal. The audio encoding and decoding system provided in this embodiment of this application includes one compatible layer and one enhancement layer. The compatible layer can completely implement an audio encoding and decoding function, and a generated bitstream is fully compatible with an old encoding and decoding system. An input of the compatible layer is an original audio signal input into the audio encoding and decoding system. The compatible layer encodes/decodes all spectrum components of the input signal. The enhancement layer can encode/decode some spectrums (for example, a high frequency domain range) of the input audio signal. A decoder side determines, based on information about the enhancement layer, whether to use a decoded audio signal that is output by the compatible layer as a final decoded output signal, or to first combine a decoded output signal of the enhancement layer and a decoded output signal of the compatible layer, and then use a combined signal as a final decoded output signal.

The encoding component 110 is configured to encode a current frame (audio signal) in frequency domain or time domain. Optionally, the encoding component 110 may be implemented by software, or may be implemented by hardware, or may be implemented in a form of a combination of software and hardware. This is not limited in embodiments of this application.

When the encoding component 110 encodes the current frame in frequency domain or time domain, in an example implementation, steps shown in FIG. 2 may be included.

201. Obtain a current frame of an audio signal, where the current frame includes a high frequency band signal and a low frequency band signal.

The current frame may be any frame in the audio signal, and the current frame may include the high frequency band signal and the low frequency band signal. Division into the high frequency band signal and the low frequency band signal may be determined based on a frequency band threshold. A signal whose frequency band is higher than the frequency band threshold is a high frequency band signal, and a signal whose frequency band is lower than the frequency band threshold is a low frequency band signal. The frequency band threshold may be determined based on a transmission bandwidth, and data processing capabilities of the encoding component 110 and the decoding component 120. This is not limited herein.

202. Obtain a compatible layer encoding parameter of the current frame based on the high frequency band signal and the low frequency band signal.

In this embodiment of this application, the high frequency band signal and the low frequency band signal may be encoded at a compatible layer. Encoding of the high frequency band signal and the low frequency band signal of the current frame is used as an example, and the compatible layer encoding parameter of the current frame can be obtained. The compatible layer encoding parameter is an encoding parameter obtained by encoding all frequency band signals of the audio signal at the compatible layer.

203. Obtain an enhancement layer encoding parameter of the current frame based on the high frequency band signal.

In this embodiment of this application, the high frequency band signal may be encoded at an enhancement layer. Encoding of the high frequency band signal of the current frame is used as an example, and the enhancement layer encoding parameter of the current frame can be obtained. The enhancement layer encoding parameter is an encoding parameter obtained by encoding the high frequency band signal of the audio signal at the enhancement layer.

In some embodiments of this application, step 203 of obtaining an enhancement layer encoding parameter of the current frame based on the high frequency band signal includes:

obtaining signal type information of the high frequency band signal of the current frame; and

encoding the high frequency band signal of the current frame when the signal type information of the high frequency band signal of the current frame indicates a preset signal type, to obtain the enhancement layer encoding parameter of the current frame.

A signal classifier may be disposed in the encoding component 110, and the signal classifier can classify audio signals input into the encoding component 110. First, the signal type information of the high frequency band signal of the current frame is obtained. The signal type information may include a plurality of types of signal classification results based on signal types obtained through classification. The high frequency band signal of the current frame is encoded when the signal type information of the high frequency band signal of the current frame indicates the preset signal type, to obtain the enhancement layer encoding parameter of the current frame. For example, audio signals may be classified into N preset signal types, and N encoding modes may be set at the enhancement layer. One corresponding enhancement layer encoding mode may be executed for each preset signal type. Therefore, corresponding enhancement layer encoding modes are used for different signal types. This improves audio signal encoding efficiency.

For example, in this embodiment of this application, the signal classifier is disposed in the encoding component, and the signal classifier may be configured to detect a specific type of audio signal. When this type of signal is detected, the high frequency band signal is encoded at the enhancement layer. When this type of signal is not detected, no encoding is performed. After encoding at the enhancement layer, a signal classification result is used for bitstream multiplexing in step 204. In addition, if the specific type of audio signal is detected, a high frequency band signal encoding parameter is also used for bitstream multiplexing in step 204; or if the specific type of audio signal is not detected, bitstream multiplexing is not performed. In this embodiment of this application, the encoding component selects appropriate enhancement layer encoding for processing by using the signal classification result, so that a decoder side may also use the signal classification result to perform decoding at the enhancement layer based on different preset signal types. Therefore, the enhancement layer signal may be used to process a part of spectrum processed at the compatible layer, to improve performance of a final output signal.

In some embodiments of this application, the preset signal type includes at least one of the following: a harmonic signal type, a tonal signal type, a white noise-like signal type, a transient signal type, or a fricative signal type.

The high frequency band signal of the current frame may have a plurality of preset signal types. For example, if the signal type of the high frequency band signal of the current frame is the harmonic signal type, that is, if the high frequency band signal of the current frame is a harmonic signal, an enhancement layer encoding mode 1 may be used to encode the harmonic signal at the enhancement layer. If the signal type of the high frequency band signal of the current frame is the tonal signal type, that is, if the high frequency band signal of the current frame includes a tonal component, an enhancement layer encoding mode 2 may be used to encode a tonal signal at the enhancement layer. If the signal type of the high frequency band signal of the current frame is the white noise-like signal type, that is, if the high frequency band signal of the current frame includes a white noise-like signal, an enhancement layer encoding mode 3 may be used to encode the white noise-like signal at the enhancement layer. If the signal type of the high frequency band signal of the current frame is the transient signal type, that is, if the high frequency band signal of the current frame includes a transient signal, an enhancement layer encoding mode 4 may be used to encode the transient signal at the enhancement layer. If the signal type of the high frequency band signal of the current frame is the fricative signal type, that is, if the high frequency band signal of the current frame includes a fricative signal, an enhancement layer encoding mode 5 may be used to encode the fricative signal at the enhancement layer. In this embodiment of this application, one corresponding enhancement layer encoding mode may be executed for each preset signal type. Therefore, corresponding enhancement layer encoding modes are used for different signal types. This improves audio signal encoding efficiency.

It may be understood that, in this embodiment of this application, if the high frequency band signal of the current frame is not of the foregoing preset signal type, the high frequency band signal may not be encoded at the enhancement layer herein.

In some embodiments of this application, the enhancement layer encoding parameter of the current frame further includes the signal type information of the high frequency band signal of the current frame.

The encoding component 110 may identify the high frequency band signal of the current frame for the audio signal based on the preset signal type, and the encoding component 110 may generate the signal type information of the high frequency band signal of the current frame. The enhancement layer encoding parameter generated after the high frequency band signal of the current frame is encoded at the enhancement layer further includes the signal type information of the high frequency band signal of the current frame. Therefore, during bitstream multiplexing, a generated encoded bitstream may carry the signal type information of the high frequency band signal of the current frame, so that a decoding component may also use the signal type information to perform decoding at the enhancement layer based on different preset signal types. Therefore, an enhancement layer signal may be used to process a part of spectrum processed at the compatible layer, to improve performance of a final output signal.

In some embodiments of this application, step 203 of obtaining an enhancement layer encoding parameter of the current frame based on the high frequency band signal includes:

obtaining compatible layer encoding frequency band information;

determining a to-be-encoded frequency band signal in the high frequency band signal of the current frame based on the compatible layer encoding frequency band information; and

encoding the to-be-encoded frequency band signal to obtain the enhancement layer encoding parameter.

The encoding component 110 may further obtain the compatible layer encoding frequency band information. The compatible layer encoding frequency band information indicates frequency band information of the audio signal encoded at the compatible layer, that is, a specific frequency band or specific frequency bands on which compatible layer encoding is performed at the compatible layer can be determined based on the compatible layer encoding frequency band information. The to-be-encoded frequency band signal in the high frequency band signal of the current frame is determined based on the compatible layer encoding frequency band information. A high frequency band signal that needs to be encoded at the enhancement layer may be determined based on the compatible layer encoding frequency band information. Finally, the to-be-encoded frequency band signal that needs to be encoded at the enhancement layer is encoded, to obtain the enhancement layer encoding parameter. In this embodiment of this application, the compatible layer encoding frequency band information that is output at the compatible layer may be used to guide encoding at the enhancement layer on an encoder side, so that encoding at the enhancement layer and encoding at the compatible layer can be complementary. This improves audio signal encoding efficiency at the enhancement layer.

For example, at the enhancement layer, specific high frequency band spectrum components on which enhancement layer encoding is to be performed are determined based on enhancement layer signal classification information and the compatible layer encoding frequency band information. For example, the signal classification information indicates that enhancement layer encoding needs to be performed on four frequency domain sub-bands of the current frame. However, the encoding frequency band information that is output by the compatible layer indicates that one of the four frequency domain sub-bands is to be encoded through compatible layer encoding. Therefore, enhancement layer encoding may be performed on the remaining three frequency domain sub-bands at the enhancement layer, and no enhancement layer frequency domain encoding is performed on the one frequency domain sub-band that has been encoded at the compatible layer. This reduces a quantity of frequency domain sub-bands that need to be encoded at the enhancement layer, and improves audio signal encoding efficiency at the enhancement layer.

204. Perform bitstream multiplexing on the compatible layer encoding parameter and the enhancement layer encoding parameter to obtain an encoded bitstream.

In this embodiment of this application, after compatible layer encoding and enhancement layer encoding are completed, bitstream multiplexing may be performed, so that the compatible layer encoding parameter and the enhancement layer encoding parameter can be multiplexed into one encoded bitstream, that is, the encoded bitstream may include the compatible layer encoding parameter and the enhancement layer encoding parameter.

205. Send the encoded bitstream to the decoding component.

In this embodiment of this application, after completing encoding, the encoding component 110 may generate the encoded bitstream, and the encoding component 110 may send the encoded bitstream to the decoding component 120, so that the decoding component 120 may receive the encoded bitstream, and then the decoding component 120 obtains an audio output signal from the encoded bitstream.

It should be noted that the encoding method shown in FIG. 2 is merely an example but not a limitation, and an execution sequence of the steps in FIG. 2 is not limited in this embodiment of this application. The encoding method shown in FIG. 2 may alternatively include more or fewer steps. This is not limited in this embodiment of this application.

It can be learned from the example description of the encoding method in this application in the foregoing embodiment that the current frame of the audio signal is obtained, where the current frame includes the high frequency band signal and the low frequency band signal; the compatible layer encoding parameter of the current frame is obtained based on the high frequency band signal and the low frequency band signal; the enhancement layer encoding parameter of the current frame is obtained based on the high frequency band signal; and bitstream multiplexing is performed on the compatible layer encoding parameter and the enhancement layer encoding parameter to obtain the encoded bitstream. In this embodiment of this application, all frequency domain ranges for encoding the audio signal may be included at the compatible layer, but only a high frequency domain range for encoding the audio signal is included at the enhancement layer. The compatible layer may be implemented by using an old audio encoding device, and the enhancement layer and the compatible layer may be implemented by using a new audio encoding device. Therefore, in this embodiment of this application, the new audio encoding device is compatible with the old audio encoding device. According to a device type of the audio encoding device, encoding may be performed at only the compatible layer, or at both the compatible layer and the enhancement layer. In this embodiment of this application, no new transcoding module needs to be added to the old audio encoding device. Therefore, upgrade costs of the audio encoding device are reduced, and audio signal encoding efficiency can be improved.

Optionally, the encoding component 110 and the decoding component 120 may be connected in a wired or wireless manner, and the decoding component 120 may obtain, through a connection between the decoding component 120 and the encoding component 110, the encoded bitstream generated by the encoding component 110. Alternatively, the encoding component 110 may store the generated encoded bitstream in a memory, and the decoding component 120 reads the encoded bitstream in the memory.

Optionally, the decoding component 120 may be implemented by software, or may be implemented by hardware, or may be implemented in a form of a combination of software and hardware. This is not limited in embodiments of this application.

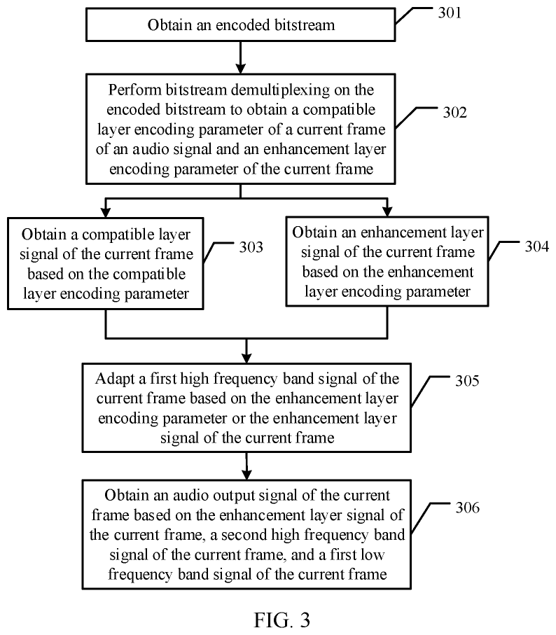

When the decoding component 120 decodes a current frame (audio signal) in frequency domain or time domain, in an example implementation, steps shown in FIG. 3 may be included.

301. Obtain an encoded bitstream.

The encoded bitstream is sent by the encoding component 110 to the decoding component 120. The encoded bitstream may include a compatible layer encoding parameter and an enhancement layer encoding parameter.

302. Perform bitstream demultiplexing on the encoded bitstream to obtain the compatible layer encoding parameter of the current frame of the audio signal and the enhancement layer encoding parameter of the current frame.

In this embodiment of this application, after obtaining the encoded bitstream, the decoding component 120 performs bitstream demultiplexing on the current frame of the audio signal in the encoded bitstream, to obtain the compatible layer encoding parameter of the current frame and the enhancement layer encoding parameter of the current frame.

303. Obtain a compatible layer signal of the current frame based on the compatible layer encoding parameter, where the compatible layer signal includes a first high frequency band signal of the current frame and a first low frequency band signal of the current frame.

In this embodiment of this application, the compatible layer encoding parameter may be decoded at a compatible layer to obtain the compatible layer signal of the current frame. With reference to the foregoing description of the compatible layer, decoding is performed in all frequency domain ranges of the audio signal at the compatible layer. Therefore, the obtained compatible layer signal includes the first high frequency band signal of the current frame and the first low frequency band signal of the current frame, that is, the first high frequency band signal and the first low frequency band signal are obtained through decoding at the compatible layer.

304. Obtain an enhancement layer signal of the current frame based on the enhancement layer encoding parameter.

In this embodiment of this application, the enhancement layer encoding parameter may be decoded at an enhancement layer to obtain the enhancement layer signal of the current frame. With reference to the foregoing description of the enhancement layer, a high frequency range of the audio signal is decoded at the enhancement layer. Therefore, the obtained enhancement layer signal includes a high frequency band signal of the current frame, that is, the high frequency band signal is obtained through decoding at the enhancement layer.

It should be noted that if the decoding component 120 is an old decoding component, all frequency domain signals of the audio signal can be obtained by performing only step 303. If the decoding component 120 is a new decoding component, step 303 and step 304 need to be performed to separately obtain the compatible layer signal and the enhancement layer signal.

In some embodiments of this application, the obtaining an enhancement layer signal of the current frame based on the enhancement layer encoding parameter includes:

obtaining signal type information based on the enhancement layer encoding parameter of the current frame; and

decoding the enhancement layer encoding parameter of the current frame based on a preset signal type indicated by the signal type information, to obtain the enhancement layer signal of the current frame.

The encoded bitstream may carry the signal type information of the audio signal, and after performing bitstream demultiplexing on the encoded bitstream, the decoding component can obtain the signal type information of the enhancement layer encoding parameter of the current frame. The enhancement layer encoding parameter of the current frame is decoded based on the preset signal type indicated by the signal type information, to obtain the enhancement layer signal of the current frame. For example, audio signal may be classified into N preset signal types, and N decoding modes may be set at the enhancement layer. One corresponding enhancement layer decoding mode may be executed for each preset signal type. Therefore, corresponding enhancement layer decoding modes are used for different signal types. This improves audio signal decoding efficiency. In this embodiment of this application, the decoding component selects appropriate enhancement layer decoding for processing based on the signal type information. Therefore, the enhancement layer signal may be used to process a part of spectrum processed at the compatible layer, to improve performance of a final output signal.

In some embodiments of this application, step 304 of obtaining an enhancement layer signal of the current frame based on the enhancement layer encoding parameter includes:

determining a to-be-decoded enhancement layer high frequency band signal in the enhancement layer encoding parameter based on the enhancement layer encoding parameter and the compatible layer encoding parameter; and

decoding the to-be-decoded enhancement layer high frequency band signal in the enhancement layer encoding parameter, to obtain the enhancement layer signal of the current frame.

The decoding component may obtain the enhancement layer encoding parameter and the compatible layer encoding parameter. The decoding component determines, based on the enhancement layer encoding parameter and the compatible layer encoding parameter, a high frequency band signal that needs to be decoded at the enhancement layer in the enhancement layer encoding parameter (namely, the to-be-decoded enhancement layer high frequency band signal), and then decodes the high frequency band signal that needs to be decoded at the enhancement layer. A high frequency band signal that is in the enhancement layer encoding parameter and that is not determined as a to-be-decoded signal may be discarded. Therefore, only the to-be-decoded enhancement layer high frequency band signal needs to be decoded, and not all of the enhancement layer encoding parameter needs to be decoded. This improves audio signal decoding efficiency at the enhancement layer.

In this embodiment of this application, a specific frequency band or specific frequency bands on which enhancement layer decoding is to be performed at the enhancement layer may be determined based on the enhancement layer encoding parameter and the compatible layer encoding parameter. In this embodiment of this application, the enhancement layer encoding parameter and the compatible layer encoding parameter may be used to guide decoding at the enhancement layer on a decoder side, so that decoding at the enhancement layer and decoding at the compatible layer can be complementary. This improves audio signal decoding efficiency at the enhancement layer.

For example, at the enhancement layer, the to-be-decoded enhancement layer high frequency band signal in the enhancement layer encoding parameter is determined based on the enhancement layer encoding parameter and the compatible layer encoding parameter, that is, specific high frequency band spectrum components on which enhancement layer decoding is to be performed may be determined. With reference to the example description of the foregoing enhancement layer encoding process, it can be learned that the signal classification information indicates that enhancement layer encoding needs to be performed on four frequency domain sub-bands of the current frame. However, the encoding frequency band information that is output by the compatible layer indicates that one of the four frequency domain sub-bands is to be encoded through compatible layer encoding. Therefore, enhancement layer encoding may be performed on the remaining three frequency domain sub-bands at the enhancement layer, and no enhancement layer frequency domain encoding is performed on the one frequency domain sub-band that has been encoded at the compatible layer. A decoder-side processing process is as follows: Three frequency domain sub-band signals are output through enhancement layer decoding, three corresponding frequency domain sub-band signals in a signal that is output through compatible layer decoding and the three frequency domain sub-band signals in the enhancement layer signal are combined into three frequency domain sub-band spectrum components of a final output signal, and the three frequency domain sub-band spectrum components are used together with all the other sub-band signals to obtain the final output signal. In this embodiment of this application, a quantity of frequency domain sub-bands that need to be decoded at the enhancement layer can be reduced, and audio signal decoding efficiency at the enhancement layer can be improved.

305. Adapt the first high frequency band signal of the current frame based on the enhancement layer encoding parameter or the enhancement layer signal of the current frame, to obtain a second high frequency band signal of the current frame.

In this embodiment of this application, the first high frequency band signal at the compatible layer may be adapted based on the enhancement layer encoding parameter or the enhancement layer signal of the current frame. Therefore, the first high frequency band signal at the compatible layer is adapted, and the second high frequency band signal of the current frame at the compatible layer is obtained. In this embodiment of this application, the enhancement layer encoding parameter or the enhancement layer signal of the current frame may be used to adapt the first high frequency band signal at the compatible layer, to improve performance of a final audio output signal.

In this embodiment of this application, the first high frequency band signal of the current frame may be adapted based on the enhancement layer signal of the current frame. The adaptation refers to adjusting the first high frequency band signal at the compatible layer, to improve performance of a high frequency band signal that is output through compatible layer decoding. There are a plurality of adaptation manners in this embodiment of this application. The following describes adaptation in detail by using examples.

Adaptation Manner 1:

In some embodiments of this application, step 305 of adapting the first high frequency band signal of the current frame based on the enhancement layer encoding parameter or the enhancement layer signal of the current frame, to obtain a second high frequency band signal of the current frame includes:

obtaining a compatible layer high frequency band adjustment parameter based on the enhancement layer encoding parameter or the enhancement layer signal of the current frame and the first high frequency band signal of the current frame; and

adapting the first high frequency band signal of the current frame by using the compatible layer high frequency band adjustment parameter, to obtain the second high frequency band signal of the current frame.

The decoding component 120 may obtain the compatible layer high frequency band adjustment parameter based on the enhancement layer encoding parameter or the enhancement layer signal and the first high frequency band signal at the compatible layer. The compatible layer high frequency band adjustment parameter (which may be referred to as an adjustment parameter for short in the following embodiments) is an adjustment parameter used to adjust a high frequency part of the compatible layer signal. For example, the compatible layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated based on the enhancement layer signal of the current frame and the first high frequency band signal of the current frame, and the first high frequency band signal of the current frame is adapted by using the adjustment parameter, to obtain the second high frequency band signal of the current frame. Adapting the first high frequency band signal by using the adjustment parameter can obtain a better compatible layer high frequency band signal, so that a better audio output signal is output, and performance of the audio output signal is improved.

For example, the adjustment parameter may be obtained based on the enhancement layer signal of the current frame and the first high frequency band signal of the current frame, a high frequency band spectrum component of the compatible layer signal is adapted by using the adjustment parameter, and a final output signal may be obtained after the enhancement layer signal is combined with an adapted compatible layer signal.

In some embodiments of this application, the obtaining a compatible layer high frequency band adjustment parameter based on the enhancement layer encoding parameter or the enhancement layer signal of the current frame and the first high frequency band signal of the current frame includes:

obtaining envelope information corresponding to the enhancement layer encoding parameter or the enhancement layer signal of the current frame, and obtaining envelope information of the first high frequency band signal of the current frame; and

obtaining the compatible layer high frequency band adjustment parameter based on the envelope information corresponding to the enhancement layer encoding parameter or the enhancement layer signal and the envelope information of the first high frequency band signal.

The decoding component may directly obtain compatible layer output information through parsing from the compatible layer, the output information and the enhancement layer signal are used for joint calculation to obtain a high frequency band spectrum adjustment parameter of the compatible layer signal, and a high frequency band signal of the compatible layer signal is adjusted by using the adjustment parameter and is combined with an enhancement layer output signal to obtain a final output signal. The adjustment parameter may be calculated in a plurality of implementations. The adjustment parameter may be calculated based on the envelope information corresponding to the enhancement layer encoding parameter or the enhancement layer signal and the envelope information of the first high frequency band signal. The envelope information corresponding to the enhancement layer encoding parameter may be envelope information that is of a high frequency band signal and that is calculated based on the enhancement layer encoding parameter, or the envelope information corresponding to the enhancement layer signal may be an amplitude of the enhancement layer signal, and the envelope information of the first high frequency band signal may be an amplitude of the high frequency band signal in the compatible layer signal. The compatible layer high frequency band adjustment parameter may be calculated based on the envelope information corresponding to the enhancement layer encoding parameter or the enhancement layer signal and the envelope information of the first high frequency band signal. There may be a plurality of manners for calculating the compatible layer high frequency band adjustment parameter.

For example, if envelope information of a high frequency band signal that is output by a decoder at the compatible layer is Envelope, and envelope information of a tonal component that is output by the enhancement layer is EnvTonal, an adjustment parameter para=(Envelope−EnvTonal)/Envelope is first calculated, the high frequency band part of the compatible layer signal is multiplied by the adjustment parameter para to obtain an adjusted compatible layer signal, and the final output signal is obtained after the enhancement layer signal and the adjusted compatible layer signal are combined.

In this embodiment, because the compatible layer high frequency band adjustment parameter may be directly obtained from the compatible layer, the final output signal is obtained after the compatible layer signal is adjusted by using the compatible layer high frequency band adjustment parameter and is combined with the enhancement layer output. A better compatible layer high frequency band signal can be obtained, so that a better audio output signal is output, and performance of the audio output signal is improved.

Adaptation Manner 2:

In some embodiments of this application, step 305 of adapting the first high frequency band signal of the current frame based on the enhancement layer encoding parameter or the enhancement layer signal of the current frame, to obtain a second high frequency band signal of the current frame includes:

selecting an enhancement layer high frequency band spectrum signal of the current frame from the enhancement layer signal of the current frame according to a preset high frequency band spectrum selection rule; and

combining the enhancement layer high frequency band spectrum signal and the first high frequency band signal of the current frame, to obtain the second high frequency band signal of the current frame.

The high frequency band spectrum selection rule may be preset in the decoding component. The high frequency band spectrum selection rule may be used to indicate to select the high frequency band spectrum signal from the enhancement layer signal. For example, the high frequency band spectrum selection rule specifies one or more selected frequency bands, or the high frequency band spectrum selection rule indicates a frequency band that needs to be selected from the enhancement layer signal. The enhancement layer high frequency band spectrum signal of the current frame is selected from the enhancement layer signal of the current frame according to the preset high frequency band spectrum selection rule. The enhancement layer high frequency band spectrum signal is a selected high frequency band spectrum signal in the enhancement layer signal. The enhancement layer high frequency band spectrum signal is combined with the first high frequency band signal of the current frame to obtain the second high frequency band signal of the current frame. In this embodiment of this application, the high frequency band spectrum selection rule is set, so that some high frequency band signals may be selected from the enhancement layer signal and combined with the first high frequency band signal at the compatible layer, to generate the second high frequency band signal at the compatible layer. Therefore, in this embodiment of this application, a better compatible layer high frequency band signal can be obtained, so that a better audio output signal is output, and performance of the audio output signal is improved.

In some embodiments of this application, the selecting an enhancement layer high frequency band spectrum signal of the current frame from the enhancement layer signal of the current frame according to a preset high frequency band spectrum selection rule includes:

obtaining a compatible layer decoded signal and a compatible layer bandwidth extension signal that are included in the first high frequency band signal of the current frame; and

determining, as the enhancement layer high frequency band spectrum signal of the current frame, a signal that is in the enhancement layer signal of the current frame and that corresponds to the compatible layer bandwidth extension signal.

The decoding component may determine the compatible layer decoded signal and the compatible layer bandwidth extension signal that are included in the first high frequency band signal. The compatible layer decoded signal is a signal obtained by the decoding component by decoding the compatible layer encoding parameter at the compatible layer, and the compatible layer bandwidth extension signal is a signal obtained by the decoding component through bandwidth extension at the compatible layer. For example, a low frequency band signal is extended to a high frequency band, to obtain the compatible layer bandwidth extension signal. In this embodiment of this application, the decoding component may select the enhancement layer high frequency band spectrum signal of the current frame from the enhancement layer signal of the current frame based on the compatible layer bandwidth extension signal. In other words, a signal that is in the enhancement layer signal and that corresponds to the compatible layer decoded signal at the compatible layer is not selected. In this way, the enhancement layer high frequency band spectrum signal is a spectrum signal selected from the enhancement layer signal, and after the compatible layer signal is adjusted by using the enhancement layer high frequency band spectrum signal and an adjusted signal is combined with an enhancement layer output, a final output signal is obtained. A better compatible layer high frequency band signal can be obtained, so that a better audio output signal is output, and performance of the audio output signal is improved.

For example, in this embodiment of this application, after selection is performed on the enhancement layer signal by analyzing a compatible layer output signal, the final output signal is obtained after the selected signal is combined with the compatible layer signal. A selection principle may include: The compatible layer signal includes an encoded/decoded part and a bandwidth extension part. The enhancement layer signal needs to be combined with the bandwidth extension part of the compatible layer signal to obtain a high frequency band part of the final output signal. If a corresponding spectrum component in the compatible layer signal and a corresponding spectrum component in the enhancement layer signal are obtained through encoding/decoding, such part of spectrum component in the enhancement layer signal is not selected for the high frequency band part of the final output signal. Otherwise, such part of spectrum component in the enhancement layer signal is selected for combination with such part of spectrum component in the compatible layer signal to obtain such part of spectrum component in the final output signal.

A difference between the adaptation manner 2 and the adaptation manner 1 lies in that a part of component of the enhancement layer signal needs to be selected for combination with the compatible layer signal to obtain the final output signal, and a part of spectrum component of the enhancement layer signal is discarded. For example, there is a tonal component at a frequency in the enhancement layer signal, and there is also a tonal component with equal energy near the frequency in the compatible layer signal. In this case, it may be determined that the tonal component in the compatible layer signal is directly obtained through encoding/decoding. Therefore, in this case, the tonal component that is output at the frequency at the enhancement layer is discarded, and the tonal component at the frequency at the compatible layer is directly used as a spectrum output at the frequency in the final output signal.

It can be learned from the foregoing example description that, in this embodiment, the spectrum component in the enhancement layer signal and the corresponding spectrum component in the compatible layer signal are compared through analysis. A conclusion is that a part of spectrum component in the enhancement layer signal is discarded, and the other part of spectrum component is combined with the compatible layer signal into the final output signal. In other words, a better output signal may be obtained based on the enhancement layer signal and the compatible layer signal.

In some embodiments of this application, the enhancement layer signal may be a frequency domain signal, and the compatible layer signal may be a time domain signal. In a combination procedure, the compatible layer signal may be first converted into a frequency domain signal, and after adaptation and combination are performed on a frequency domain coefficient of the enhancement layer signal and a frequency domain coefficient of the compatible layer signal, the frequency domain signal is converted into a time domain signal, to obtain the final output signal.

Adaptation Manner 3:

In some embodiments of this application, step 305 of adapting the first high frequency band signal of the current frame based on the enhancement layer encoding parameter or the enhancement layer signal of the current frame, to obtain a second high frequency band signal of the current frame includes:

replacing the first high frequency band signal of the current frame with the enhancement layer signal of the current frame, to obtain the second high frequency band signal of the current frame.

An adaptation implementation may be direct replacement. The decoding component may replace the first high frequency band signal of the current frame with the enhancement layer signal of the current frame. In other words, the first low frequency band signal at the compatible layer remains unchanged, the first high frequency band signal at the compatible layer may be replaced with the enhancement layer signal of the current frame, and the enhancement layer signal of the current frame may be used as the adapted second high frequency band signal. Therefore, in this embodiment of this application, a better compatible layer high frequency band signal can be obtained, so that a better audio output signal is output, and performance of the audio output signal is improved.

The following describes the adaptation manner 3 by using an example. After the decoding component replaces a part of spectrum component of the compatible layer signal with the enhancement layer signal, the final output signal is obtained.

A difference between the adaptation manner 3 and the adaptation manner 1 or 2 lies in that a part of spectrum component of the compatible layer signal is replaced with the enhancement layer signal in the adaptation manner 3. For example, the compatible layer signal is Ylc(n), and the enhancement layer signal is Yel(n). A high frequency band spectrum HF in the compatible layer signal Ylc(n) is removed, and a signal HFe represented by Yel(n) and a low frequency band spectrum LF in Ylc(n) are combined into a final output signal Y(n).

For example, the compatible layer signal is a time domain signal Ylc(t), and the enhancement layer signal is a time domain signal Yel(t). In this case, after low-pass filtering is first performed on the time domain signal Ylc(t), and the time domain signal Ylc(t) is superimposed on the time domain signal Yel(t), a final output signal is obtained, that is, an output signal Y(t) is obtained according to the following formula: Y(t)=LowFilter(Ylc(t))+Yel(t). For example, the compatible layer signal is a frequency domain signal Ylc(k), and the enhancement layer signal is a frequency domain signal Yel(k). After a compatible layer frequency domain coefficient Ylc(k) is directly replaced with an enhancement layer frequency domain coefficient Yel(k), a final spectral coefficient is obtained, and the spectral coefficient is converted into a time domain signal as a final output signal, that is, an output signal Y(t) is obtained according to the following formulas:

Y(k)=Ylc(k), where k=0,1,2, . . . , or M−V; and

Y(k)=Yel(k−M+V−1), where k=M−V+1,M−V+2, . . . , or M.

Finally, Y(k) is converted into a time domain signal Y(t) as the final output signal.

A part of spectrum component in the compatible layer signal is replaced with a spectrum component that is output at the enhancement layer, so that an output signal whose encoding/decoding performance is better than that of the compatible layer signal is obtained. For example, the compatible layer in this embodiment is fully backward-compatible with an old codec. In this embodiment, the enhancement layer encodes/decodes some types of signals based on the signal classification information, and the final output signal is obtained after the decoder side replaces a part of spectrum component in the output signal at the compatible layer with a spectrum component in the output signal at the enhancement layer based on the signal classification information.

Further, in some embodiments of this application, the replacing the first high frequency band signal of the current frame with the enhancement layer signal of the current frame, to obtain the second high frequency band signal of the current frame includes:

obtaining an enhancement layer high frequency band adjustment parameter based on the enhancement layer encoding parameter or the enhancement layer signal of the current frame and the first high frequency band signal of the current frame;

adapting the enhancement layer signal of the current frame by using the enhancement layer high frequency band adjustment parameter, to obtain an adapted enhancement layer signal; and

replacing the first high frequency band signal of the current frame with the adapted enhancement layer signal, to obtain the second high frequency band signal of the current frame.

The decoding component 120 may obtain the enhancement layer high frequency band adjustment parameter based on the enhancement layer signal and the first high frequency band signal at the compatible layer. The enhancement layer high frequency band adjustment parameter (which may be referred to as an adjustment parameter for short in the following embodiments) is an adjustment parameter used to adjust the enhancement layer signal. The enhancement layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated by using the enhancement layer signal of the current frame and the first high frequency band signal of the current frame, and the enhancement layer signal of the current frame is adapted by using the adjustment parameter, to obtain the adapted enhancement layer signal. The enhancement layer signal of the current frame is adapted by using the adjustment parameter, and then the first high frequency band signal of the current frame is replaced with the adapted enhancement layer signal. In this way, a better compatible layer high frequency band signal can be obtained, so that a better audio output signal is output, and performance of the audio output signal is improved.

In some other embodiments of this application, the replacing the first high frequency band signal of the current frame with the enhancement layer signal of the current frame, to obtain the second high frequency band signal of the current frame includes:

obtaining an enhancement layer high frequency band adjustment parameter based on the enhancement layer encoding parameter or the enhancement layer signal of the current frame and the first high frequency band signal of the current frame;

replacing the first high frequency band signal of the current frame with the enhancement layer signal of the current frame, to obtain a first high frequency band signal generated after the replacement; and

adapting, by using the enhancement layer high frequency band adjustment parameter, the first high frequency band signal generated after the replacement, to obtain the second high frequency band signal of the current frame.

The decoding component 120 may obtain the enhancement layer high frequency band adjustment parameter based on the enhancement layer signal and the first high frequency band signal at the compatible layer. The enhancement layer high frequency band adjustment parameter (which may be referred to as an adjustment parameter for short in the following embodiments) is an adjustment parameter used to adjust the enhancement layer signal. The enhancement layer high frequency band adjustment parameter may be obtained based on the enhancement layer signal of the current frame and the first high frequency band signal of the current frame. Both the enhancement layer signal of the current frame and the first high frequency band signal of the current frame are high frequency band audio signals. An adjustment parameter may be calculated by using the enhancement layer signal of the current frame and the first high frequency band signal of the current frame, and after the first high frequency band signal generated after the replacement is obtained, the first high frequency band signal generated after the replacement is adapted by using the adjustment parameter, to obtain the second high frequency band signal of the current frame. Adapting, by using the adjustment parameter, the first high frequency band signal generated after the replacement can obtain a better compatible layer high frequency band signal, so that a better audio output signal is output, and performance of the audio output signal is improved.

For example, after the enhancement layer signal is adapted to replace a part of spectrum component of the compatible layer signal, and after combination with another spectrum component at the compatible layer, the final output signal is obtained. Alternatively, after a part of spectrum component of the compatible layer signal is replaced with the enhancement layer signal, adaptation is performed, and after combination with another spectrum component at the compatible layer, the final output signal is obtained.

In this embodiment, the spectrum component of the enhancement layer signal needs to be adapted before or after the spectrum component corresponding to the compatible layer is replaced. Details are as follows:

If the compatible layer signal is a time domain signal Ylc(t), and the enhancement layer signal is a time domain signal Yel(t), after low-pass filtering and adaptation are first performed on the time domain signal Ylc(t), and the time domain signal Ylc(t) is superimposed on the time domain signal Yel(t), a final output signal is obtained, that is, an output signal Y(t) is obtained according to the following formula:

Y(t)=LowFilter(Ylc(t))+Preprocessing(Yel(t)).

Specifically, adaptation (Preprocessing) may include a plurality of processing algorithms. For example, it is assumed that total energy of the enhancement layer signal Yel(t) is EnerEL, high frequency band spectrum component energy corresponding to the compatible layer signal is EnerLC, and the adjustment parameter is calculated in the following manner: para=sqrt(EnerLC/EnerEL). Then, the adjustment parameter para is multiplied by the enhancement layer signal Yel(t) to obtain an adapted enhancement layer signal, and the final output signal may be obtained based on the adapted enhancement layer signal and the compatible layer signal obtained after low-pass filtering.

For another example, the compatible layer signal is a frequency domain signal Ylc(k), a high frequency band spectrum component energy corresponding to the compatible layer signal is EnerLC, the enhancement layer signal is a frequency domain signal Yel(k), energy of the enhancement layer signal is EnerEL, and the adjustment parameter is calculated in the following manner: para=sqrt(EnerLC/EnerEL). Then, after the adjustment parameter para is multiplied by the enhancement layer signal Yel(k), an adapted enhancement layer frequency domain coefficient is obtained, and the adapted enhancement layer frequency domain coefficient is combined with a compatible layer low frequency band frequency domain coefficient to obtain a frequency domain coefficient of an output signal. Specifically, an output signal Y(t) is obtained according to the following formulas:

para=sqrt(EnerLC/EnerEL);

Y(k)=Ylc(k), where k=0,1,2, . . . , or M−V; and

Y(k)=para*Yel(k−M+V−1), where k=M−V+1,M−V+2, . . . , or M.

Finally, frequency-to-time conversion is performed on Y(k) to obtain a time domain signal Y(t) as the final output signal.

In this embodiment, in the manner in which the spectrum component corresponding to the compatible layer signal is replaced with the adapted enhancement layer signal, encoding/decoding performance of the final output signal is improved.

In some other embodiments of this application, the replacing the first high frequency band signal of the current frame with the enhancement layer signal of the current frame, to obtain the second high frequency band signal of the current frame includes:

performing spectrum component comparison selection on the enhancement layer signal of the current frame and the first high frequency band signal of the current frame, to select a first enhancement layer sub-signal from the enhancement layer signal of the current frame; and

replacing, with the first enhancement layer sub-signal, a signal that is in the first high frequency band signal of the current frame and that has a same spectrum as the first enhancement layer sub-signal, to obtain the second high frequency band signal of the current frame.

The decoding component may compare a spectrum component corresponding to the enhancement layer signal with a spectrum component corresponding to the first high frequency band signal in the compatible layer signal. After the spectrum component comparison is completed, the first enhancement layer sub-signal is selected from the enhancement layer signal of the current frame. Finally, the signal that is in the first high frequency band signal of the current frame and that has the same spectrum as the first enhancement layer sub-signal is replaced with the selected first enhancement layer sub-signal, to obtain the second high frequency band signal of the current frame. For example, the decoding component performs the foregoing spectrum component comparison selection. According to a comparison result, some spectrum components in the enhancement layer signal are used to replace corresponding spectrum components in the compatible layer signal, to obtain spectrum components in a final output signal. In addition, the other spectrum components in the enhancement layer signal are discarded, and all spectrum components of the final output signal are obtained by combining the spectrum components obtained after the replacement in the compatible layer signal with the other spectrum components in the compatible layer signal.

For example, before the enhancement layer signal and the compatible layer signal are combined, the decoding component first performs a spectrum component comparison selection operation. A processing process of comparison selection is as follows: If the enhancement layer signal has a spectrum component Wk, and the compatible layer signal has a spectrum component Zk with equal energy near Wk, it is determined that the spectrum component Zk is obtained through compatible layer encoding/decoding. Zk is closer to a corresponding spectrum component in an original signal than Wk. Therefore, Zk is selected as a spectrum component of the final output signal. However, if there is no corresponding spectrum component in the compatible layer signal near Wk in the enhancement layer signal, Wk is selected as a basis for adaptation to obtain a spectrum component of the final output signal, and then all spectrum components of the final output signal are obtained after combination with another spectrum component in the compatible layer signal.

In this embodiment, the decoding component selects, based on the enhancement layer signal and the compatible layer signal, an optimal spectrum component that is of the final output signal and that corresponds to the enhancement layer signal. In this embodiment, when a high frequency band of the compatible layer signal includes a high-quality encoding/decoding spectrum component, a new spectrum component that is output by the compatible layer is selected as a spectrum component of the final output signal. In a principle of introducing enhancement layer encoding/decoding to improve overall encoding/decoding performance, a special case in which the compatible layer signal includes the high-performance encoding/decoding spectrum component is considered, and finally an optimal encoding/decoding output signal is obtained.

Adaptation Manner 4:

In some embodiments of this application, step 305 of adapting the first high frequency band signal of the current frame based on the enhancement layer encoding parameter or the enhancement layer signal of the current frame, to obtain a second high frequency band signal of the current frame includes:

obtaining a compatible layer decoded signal and a compatible layer bandwidth extension signal in the compatible layer signal of the current frame; and

combining the compatible layer bandwidth extension signal and the enhancement layer signal of the current frame, to obtain the second high frequency band signal of the current frame.

The decoding component may determine the compatible layer decoded signal and the compatible layer bandwidth extension signal that are included in the compatible layer signal. The compatible layer decoded signal is a signal obtained by the decoding component by decoding the compatible layer encoding parameter at the compatible layer, and the compatible layer bandwidth extension signal is a signal obtained by the decoding component through bandwidth extension at the compatible layer. For example, a low frequency band signal is extended to a high frequency band, to obtain the compatible layer bandwidth extension signal. In this embodiment of this application, the decoding component may combine the compatible layer bandwidth extension signal and the enhancement layer signal of the current frame. In other words, the compatible layer decoded signal in the first high frequency band signal is not combined with the enhancement layer signal, and the decoding component combines only the compatible layer bandwidth extension signal with the enhancement layer signal of the current frame. After the second high frequency band signal of the current frame is obtained, and the second high frequency band signal, the enhancement layer signal, and the first low frequency band signal are combined, a final output signal is obtained. A better compatible layer high frequency band signal can be obtained, so that a better audio output signal is output, and performance of the audio output signal is improved.

Further, in some embodiments of this application, a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY].

FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

Alternatively, FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

Specifically, the compatible layer signal may include the compatible layer decoded signal and the compatible layer bandwidth extension signal. The decoding component may determine boundaries of the compatible layer decoded signal and the compatible layer bandwidth extension signal in the compatible layer signal, so that it may be determined that the spectrum range of the compatible layer decoded signal is [0, FT], and the spectrum range of the compatible layer bandwidth extension signal is [FT, FL]. For example, in this embodiment, the decoding component may learn which spectrums in the compatible layer signal are obtained through encoding and decoding, and which spectrums in the compatible layer signal are obtained through bandwidth extension. The final output signal includes the spectrums of an encoding and decoding part in the compatible layer signal, and spectrums of a bandwidth extension part may be obtained by combining corresponding spectrum components in the enhancement layer signal and the compatible layer signal.

For example, it is assumed that an original input signal sampling frequency of an audio codec is FS, a spectrum range is 0 to FS/2, and the spectrum range of the compatible layer signal is 0 to FL, where the range 0 to FT is directly obtained through encoding/decoding, and the range FT to FL is obtained through bandwidth extension. The spectrum range of the enhancement layer signal is FX to FY, and the final output signal is Y. In this case, the foregoing processing manner may be obtained based on a value relationship of boundary values of the spectrum ranges. For example, FL=FY=FS/2, and FX≤FT, that is, the minimum spectrum range FX of the enhancement layer signal is less than the maximum spectrum range of the compatible layer decoded signal. In this case, the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal. For another example, FL=FY, and FX>FT, that is, the minimum spectrum range FX of the enhancement layer signal is greater than the maximum spectrum range of the compatible layer decoded signal. In this case, the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal. For another example, FL<FY, and FX≤FT, that is, the maximum spectrum range FY of the enhancement layer signal is greater than the spectrum range of the compatible layer bandwidth extension signal, and the minimum spectrum range FX of the enhancement layer signal is less than the maximum spectrum range of the compatible layer decoded signal. In this case, the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal. For another example, FL<FY, and FX>FT, that is, the maximum spectrum range FY of the enhancement layer signal is greater than the spectrum range of the compatible layer bandwidth extension signal, and the minimum spectrum range FX of the enhancement layer signal is greater than the maximum spectrum range of the compatible layer decoded signal. In this case, the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

In this embodiment, the compatible layer is fully backward-compatible with an old encoding/decoding component. In an adaptive output combination manner, a high-performance final output signal is generated through calculation based on the compatible layer output signal, the encoding/decoding spectrum range, and the enhancement layer signal. On the basis of ensuring that the compatible layer is fully backward-compatible with an old encoding component, an upper limit of a spectrum range of combination is an upper limit of a spectrum range of enhancement layer encoding/decoding, that is, a cut-off frequency of an original signal, and a lower limit of the spectrum range of combination is a larger value in an upper limit of the spectrum range of compatible layer encoding and a lower limit of the spectrum range of the enhancement layer signal. This ensures that the spectrum range of the final output signal includes an entire spectrum range of an input signal. In this case, the output signal has advantages of both the compatible layer signal and the enhancement layer signal.

306. Obtain an audio output signal of the current frame based on the enhancement layer signal of the current frame, the second high frequency band signal of the current frame, and the first low frequency band signal of the current frame.

In this embodiment of this application, it can be learned from the foregoing description of step 305 that, the first high frequency band signal may be adapted at the compatible layer to obtain the second high frequency band signal at the compatible layer. Finally, the first low frequency band signal that is output through decoding at the compatible layer, the enhancement layer signal at the enhancement layer, and the second high frequency band signal at the compatible layer are combined to obtain the audio output signal of the current frame. The audio output signal of the current frame may be used for audio playing of an audio playing component.

It should be noted that the decoding method shown in FIG. 3 is merely an example but not a limitation, and an execution sequence of the steps in FIG. 3 is not limited in this embodiment of this application. The decoding method shown in FIG. 3 may alternatively include more or fewer steps. This is not limited in this embodiment of this application.

In some embodiments of this application, after step 306 of obtaining an audio output signal of the current frame based on the enhancement layer signal of the current frame, the second high frequency band signal of the current frame, and the first low frequency band signal of the current frame, the decoding method provided in this embodiment of this application further includes:

post-processing the audio output signal of the current frame.

After the audio output signal of the current frame is obtained, the decoding component may further post-process the audio output signal, so that a post-processing gain can be achieved.

In some embodiments of this application, post-processing includes at least one of the following: dynamic range control, rendering, and audio mixing.

For example, the decoding component may include a post-processor. A function of the post-processor is to post-process a high frequency band signal. For example, when the audio output signal is obtained after the enhancement layer signal, the second high frequency band signal of the current frame, and the first low frequency band signal of the current frame are combined, the audio output signal is post-processed. Functions of the post-processor may include dynamic range control (dynamic range control, DRC), rendering, audio mixing, and the like. A post-processing manner used in an actual application scenario is not limited.

In some embodiments of this application, before step 306 of obtaining an audio output signal of the current frame based on the enhancement layer signal of the current frame, the second high frequency band signal of the current frame, and the first low frequency band signal of the current frame, the decoding method provided in this embodiment of this application further includes:

obtaining a post-processing parameter based on the compatible layer signal; and

post-processing the enhancement layer signal by using the post-processing parameter, to obtain a post-processed enhancement layer signal.

Before obtaining the audio output signal of the current frame, the decoding component may further obtain the post-processing parameter based on the compatible layer signal. The post-processing parameter is a parameter required for post-processing. Corresponding post-processing parameters need to be obtained based on different types of post-processing. The enhancement layer signal is post-processed by using the post-processing parameter, and after the post-processing is completed, the post-processed enhancement layer signal, the second high frequency band signal of the current frame, and the first low frequency band signal of the current frame may be combined, to obtain the audio output signal. In this embodiment of this application, the enhancement layer signal may be post-processed, so that a post-processing gain can be achieved.

For example, the enhancement layer signal is combined with the post-processed compatible layer signal to obtain the final output signal. A difference between this embodiment and the foregoing embodiment lies in that post-processing that is the same as that at the compatible layer is added to the enhancement layer. After the compatible layer signal is determined, post-processing, such as dynamic range control, rendering, and audio mixing, is performed, and then combination is performed. For example, if a signal generated after direct decoding at the compatible layer can be obtained, the enhancement layer signal is first combined with the compatible layer signal, and then the foregoing post-processing is performed. For another example, if a signal generated after direct decoding at the compatible layer cannot be obtained, the foregoing post-processing is first performed on the enhancement layer signal, and then the post-processed enhancement layer signal is combined with the compatible layer signal.

Specifically, there are a plurality of manners for post-processing the enhancement layer signal. For example, the post-processing parameter may be directly obtained from the compatible layer signal, and then the post-processing parameter is used to post-process the enhancement layer signal. For another example, through post-processing, it can be ensured that spectrum components before and after combination have similar energy relationships between intra sub-bands in terms of sub-bands, to ensure that the final audio output signal can be obtained through combination.

In this embodiment of this application, the compatible layer is fully compatible with an old encoding/decoding component, and a combined signal includes a post-processing operation performed during output at the compatible layer, so that the old encoding/decoding component can implement encoding/decoding in a full-band range of the audio signal.

It can be learned from the example description of the decoding method in this application in the foregoing embodiment that the encoded bitstream is obtained; bitstream demultiplexing is performed on the encoded bitstream to obtain the compatible layer encoding parameter of the current frame of the audio signal and the enhancement layer encoding parameter of the current frame; the compatible layer signal of the current frame is obtained based on the compatible layer encoding parameter, where the compatible layer signal includes the first high frequency band signal of the current frame and the first low frequency band signal of the current frame; the enhancement layer signal of the current frame is obtained based on the enhancement layer encoding parameter; the first high frequency band signal of the current frame is adapted based on the enhancement layer encoding parameter or the enhancement layer signal of the current frame, to obtain the second high frequency band signal of the current frame; and the audio output signal of the current frame is obtained based on the enhancement layer signal of the current frame, the second high frequency band signal of the current frame, and the first low frequency band signal of the current frame. In this embodiment of this application, all frequency domain ranges for decoding the audio signal may be included at a compatible layer, but only a high frequency domain range for decoding the audio signal is included at an enhancement layer. The compatible layer may be implemented by using an old audio decoding device, and the enhancement layer and the compatible layer may be implemented by using a new audio decoding device. Therefore, in this embodiment of this application, the new audio decoding device is compatible with the old audio decoding device. According to a device type of the audio decoding device, decoding may be performed at only the compatible layer, or at both the compatible layer and the enhancement layer. In this embodiment of this application, no new transcoding module needs to be added to the old audio decoding device. Therefore, upgrade costs of the audio decoding device are reduced, and audio signal decoding efficiency can be improved.

Optionally, the encoding component 110 and the decoding component 120 may be disposed in a same device, or may be disposed in different devices. The device may be a terminal having an audio signal processing function, such as a mobile phone, a tablet computer, a laptop portable computer, a desktop computer, a Bluetooth speaker, a recording pen, or a wearable device. Alternatively, the device may be a network element having an audio signal processing capability in a core network or a wireless network. This is not limited in this embodiment.

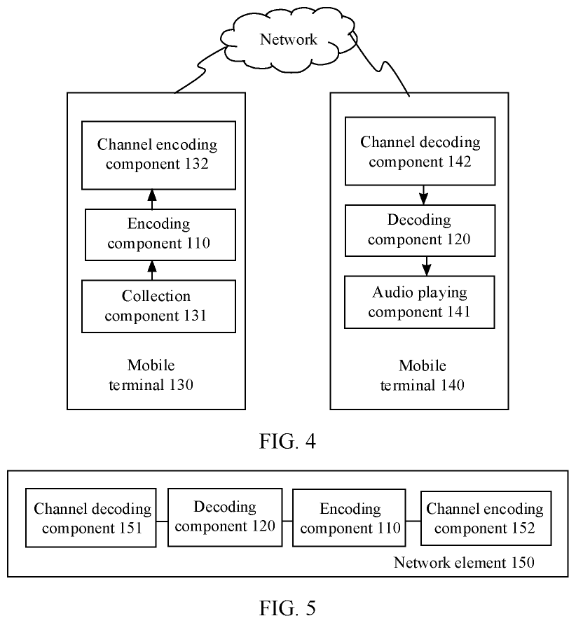

For example, as shown in FIG. 4, the following example is used for description in this embodiment. The encoding component 110 is disposed in a mobile terminal 130, and the decoding component 120 is disposed in a mobile terminal 140. The mobile terminal 130 and the mobile terminal 140 are mutually independent electronic devices having an audio signal processing capability. For example, the mobile terminal 130 and the mobile terminal 140 may be mobile phones, wearable devices, virtual reality (virtual reality, VR) devices, augmented reality (augmented reality, AR) devices, or the like. In addition, the mobile terminal 130 and the mobile terminal 140 are connected by using a wireless or wired network.

Optionally, the mobile terminal 130 may include a collection component 131, the encoding component 110, and a channel encoding component 132. The collection component 131 is connected to the encoding component 110, and the encoding component 110 is connected to the channel encoding component 132.

Optionally, the mobile terminal 140 may include an audio playing component 141, the decoding component 120, and a channel decoding component 142. The audio playing component 141 is connected to the decoding component 120, and the decoding component 120 is connected to the channel decoding component 142.

After collecting an audio signal by using the collection component 131, the mobile terminal 130 encodes the audio signal by using the encoding component 110 to obtain an encoded bitstream, and then encodes the encoded bitstream by using the channel encoding component 132 to obtain a transmission signal.

The mobile terminal 130 sends the transmission signal to the mobile terminal 140 through the wireless or wired network.

After receiving the transmission signal, the mobile terminal 140 decodes the transmission signal by using the channel decoding component 142 to obtain the encoded bitstream, decodes the encoded bitstream by using the decoding component 120 to obtain the audio signal, and plays the audio signal by using the audio playing component. It may be understood that the mobile terminal 130 may alternatively include the components included in the mobile terminal 140, and the mobile terminal 140 may alternatively include the components included in the mobile terminal 130.

For example, as shown in FIG. 5, the following example is used for description. The encoding component 110 and the decoding component 120 are disposed in one network element 150 having an audio signal processing capability in a core network or wireless network.

Optionally, the network element 150 includes a channel decoding component 151, the decoding component 120, the encoding component 110, and a channel encoding component 152. The channel decoding component 151 is connected to the decoding component 120, the decoding component 120 is connected to the encoding component 110, and the encoding component 110 is connected to the channel encoding component 152.

After receiving a transmission signal sent by another device, the channel decoding component 151 decodes the transmission signal to obtain a first encoded bitstream. The decoding component 120 decodes the encoded bitstream to obtain an audio signal. The encoding component 110 encodes the audio signal to obtain a second encoded bitstream. The channel encoding component 152 encodes the second encoded bitstream to obtain the transmission signal.

The another device may be a mobile terminal having an audio signal processing capability, or may be another network element having an audio signal processing capability. This is not limited in this embodiment.

Optionally, the encoding component 110 and the decoding component 120 in the network element may transcode the encoded bitstream sent by the mobile terminal.

Optionally, in this embodiment of this application, a device on which the encoding component 110 is installed may be referred to as an audio encoding device. In an actual implementation, the audio encoding device may also have an audio decoding function. This is not limited in this embodiment of this application.

Optionally, in this embodiment of this application, a device on which the decoding component 120 is installed may be referred to as an audio decoding device. In an actual implementation, the audio decoding device may also have an audio encoding function. This is not limited in this application.

To better understand and implement the foregoing solutions in embodiments of this application, the following uses corresponding application scenarios as examples for specific description.

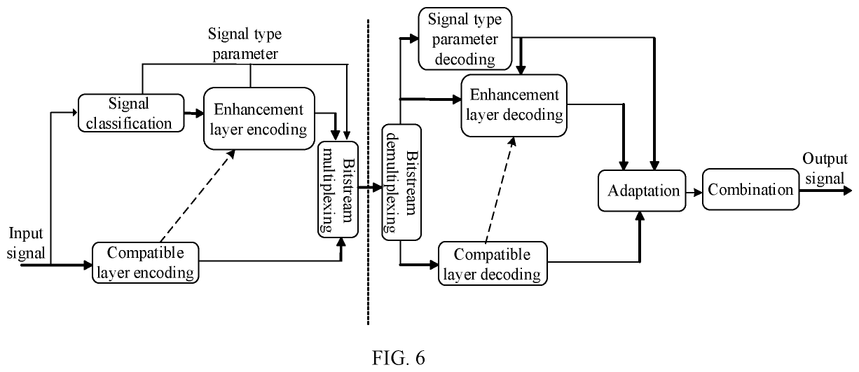

FIG. 6 is a schematic diagram of an audio encoding and decoding procedure according to an embodiment of this application. In FIG. 6, a left side of a dashed line is an encoder side, and a right side of the dashed line is a decoder side. An input signal is separately encoded at an enhancement layer and a compatible layer, and a final output of a codec is obtained after an enhancement layer signal and a compatible layer signal are combined.

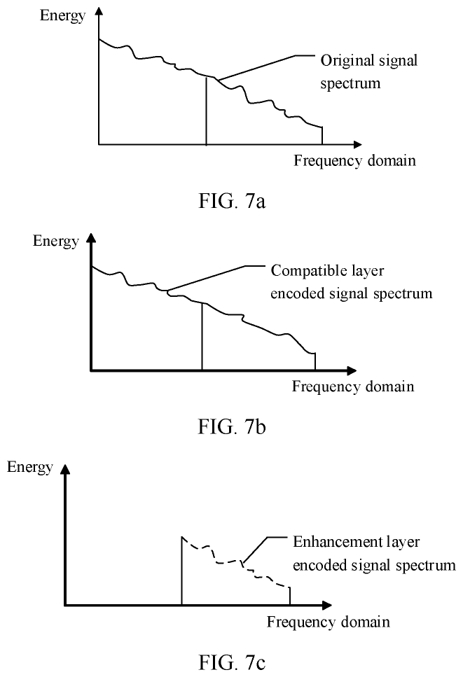

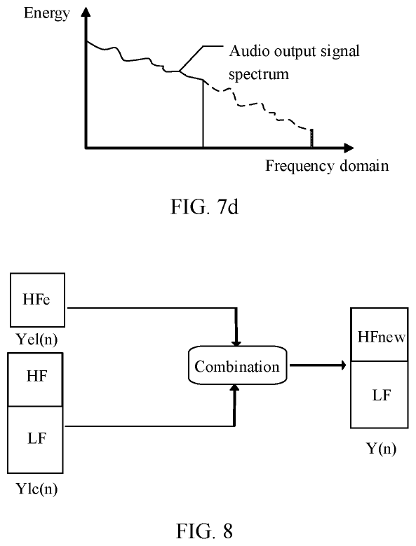

FIG. 7a is a schematic diagram of an original signal spectrum according to an embodiment of this application. A curve shown in FIG. 7a is a spectrum of an original signal on all frequency bands. On the encoder side, the compatible layer signal is first obtained by performing compatible layer encoding on the input signal. FIG. 7b is a schematic diagram of a compatible layer encoded signal spectrum according to an embodiment of this application. The compatible layer encoded signal spectrum includes a high frequency band signal and a low frequency band signal. In FIG. 7b, a left side of a vertical line is the low frequency band signal, and a right side of the vertical line is the high frequency band signal. The encoder side may further perform signal classification on the input signal. A signal type parameter is generated during signal classification, and enhancement layer encoding is performed based on the signal type parameter to obtain the enhancement layer signal. FIG. 7c is a schematic diagram of an enhancement layer encoded signal spectrum according to an embodiment of this application. A dashed line shown in FIG. 7c is a spectrum of an enhancement layer encoded signal on a high frequency band. Bitstream multiplexing is performed on the compatible layer signal, the enhancement layer signal, and the signal type parameter to obtain an encoded bitstream. FIG. 7d is a schematic diagram of an audio output signal spectrum according to an embodiment of this application. Bitstream multiplexing is performed on the compatible layer signal, the enhancement layer signal, and the signal type parameter, that is, the compatible layer encoded signal spectrum shown in FIG. 7b and the enhancement layer encoded signal spectrum shown in FIG. 7c may be combined to generate the encoded bitstream.

For example, the input signal is first input to a compatible layer encoder, and a compatible layer encoding parameter encoded by the compatible layer encoder is input to a bitstream multiplexer. The input signal may further be input to a signal classifier, and the signal type parameter is input to the bitstream multiplexer. Corresponding enhancement layer modes 1 to N are selected based on the signal type parameter to encode some spectrum components of the input signal. An enhancement layer encoding parameter encoded by an enhancement layer encoder is input to the bitstream multiplexer, and the encode bitstream that is output by the bitstream multiplexer is sent to the decoder side.

In some embodiments of this application, as shown in FIG. 6, compatible layer encoding frequency band information may further be sent to the enhancement layer encoder, so that the enhancement layer encoder may determine, based on the compatible layer encoding frequency band information, specific frequency bands on which encoding is to be performed at the enhancement layer. For details, refer to the descriptions in the foregoing embodiments. Details are not described herein again.

The decoder side first performs bitstream demultiplexing on the encoded bitstream, obtains the signal type parameter through decoding by using the signal type parameter, obtains the enhancement layer signal through enhancement layer decoding, obtains the compatible layer signal through compatible layer decoding, adapts the compatible layer signal by using the signal type parameter and the enhancement layer signal, and then combines an adapted compatible layer signal, the signal type parameter, and the enhancement layer signal to finally obtain an output signal.

For example, the decoder side inputs the compatible layer encoding parameter to a compatible layer decoder by using a bitstream demultiplexer to obtain the compatible layer signal. A signal type parameter decoder obtains the signal type parameter through decoding, and a decoder for the enhancement layer modes 1 to N obtains the enhancement layer signal through decoding based on the input corresponding bitstream and the signal type parameter. An adapter adapts the compatible layer signal by using the enhancement layer signal. Finally, the adapted compatible layer signal, the enhancement layer signal, and the signal type parameter information are input to a combiner to obtain the final output signal of the decoder from the combiner.

A compatible layer codec in this embodiment of this application may be any codec. For example, the compatible layer codec may be an MPEG-H 3D audio codec. The codec includes a time domain encoding and decoding mode and a transform domain encoding and decoding mode, and supports encoding and decoding of a multi-channel input signal. An encoding and decoding process of the compatible layer codec is not described in detail.

In some embodiments of this application, as shown in FIG. 6, the compatible layer signal may further be sent to the enhancement layer decoder, so that the enhancement layer decoder may determine, based on the compatible layer signal, specific frequency bands on which decoding is to be performed at the enhancement layer. For details, refer to the descriptions in the foregoing embodiments. Details are not described herein again.

The following describes an enhancement layer encoding and decoding manner by using examples.

A processing manner includes: The signal classifier classifies a high frequency band signal into the following three preset signal types: a harmonic signal, a signal that includes an independent tonal component, and another signal. Different processing operations are performed on the foregoing three types of signals. For example, for the harmonic signal, the encoder side may encode an encoding fundamental frequency, a harmonic quantity, an amplitude, and base energy of the harmonic signal, to obtain the enhancement layer encoding parameter. The decoder side reconstructs, at a corresponding position based on the fundamental frequency, the harmonic quantity, the amplitude, and the base energy, a harmonic signal whose energy is equivalent to that of an original signal. For another example, for the signal that includes the independent tonal component, the encoder side processes the tonal component based on a sine track curve, and the enhancement layer encoding parameter may be obtained after an amplitude, a phase, and a start point and an end point of the track curve are encoded. The enhancement layer encoding parameter is sent to the decoder side. The decoder side reconstructs, based on the amplitude, the phase, and the start point and the end point of the track curve that are obtained through decoding, the signal that includes the tonal component. For a signal other than the harmonic signal and the signal that includes the independent tonal component, the encoder side does not perform enhancement layer encoding, but directly uses the compatible layer signal as a final output signal.

Another processing manner includes: The signal classifier classifies a high frequency band signal into four types of signals: a harmonic signal, a signal that includes an independent tonal component, a white noise-like signal, and another signal. A processing manner of the harmonic signal, the signal that includes the independent tonal component, or the another signal is the same as the previous processing manner. For the white noise-like signal, the encoder side uses white noise as an excitation signal for calculation with an original high frequency band signal to obtain enhancement layer envelope information, and the enhancement layer envelope information is transmitted to the decoder side as the enhancement layer encoding parameter. The decoder side reconstructs the enhancement layer signal based on the received envelope information by using the white noise as the excitation signal.

Unlimitedly, the signal classifier may further classify a high frequency band signal into more types of signals, and generate N signal types through classfication. In this case, the enhancement layer encoder has N encoding modes, and each encoding mode is used to process one type of signal. For example, the signal classifier classifies a high frequency band signal into six types of signals: a harmonic signal, a signal that includes an independent tonal component, a white noise-like signal, a transient signal, a fricative signal, and another signal. A processing manner of the harmonic signal, the signal that includes the independent tonal component, the white noise-like signal, or the another signal is the same as the previous processing manner. For the transient signal, the enhancement layer encodes a time domain envelope more finely, so that an assignment difference between time domain envelopes of subframes included in the transient signal is more apparent. For the fricative signal, the enhancement layer performs fine encoding on a spectral envelope of the signal, so that a spectral envelope of a restored signal at the decoder side is closer to the original signal. This improves encoding performance.

FIG. 8 is a schematic diagram of an output spectrum obtained after an enhancement layer encoding parameter and a compatible layer encoding parameter are combined according to an embodiment of this application. For example, Ylc(n) represents the compatible layer encoding parameter, Ylc(n) includes a high frequency band signal HF and a low frequency signal LF, Yel(n) represents the enhancement layer encoding parameter, Yel(n) includes a high frequency band signal HFe, a final output signal obtained after the enhancement layer encoding parameter and the compatible layer encoding parameter are combined is Y(n), and Y(n) includes a high frequency band signal HFnew and the low frequency signal LF. The high frequency band signal HFnew may be a high frequency band signal obtained after an enhancement layer signal and a compatible layer signal are adapted.

For example, a specific processing procedure for a harmonic signal includes: An input signal of an encoder is x(n), where n=0, 1, 2, 3 . . . . A sampling frequency of x(n) is Fs, and a bandwidth is Fs/2. After the signal x(n) is encoded at a compatible layer, Ylc(n) whose bandwidth is Fs/2 is output, where n=0, 1, 2, 3 . . . . The signal x(n) is processed by a signal classifier, and a generated signal classification parameter is placed into an encoded bitstream. If the signal classification parameter indicates that a current frame includes the harmonic signal, the current frame is encoded at an enhancement layer. After an encoded signal is decoded, a signal Yel(n) whose frequency band is HFe is output, where n=0, 1, 2, 3 . . . .

After the foregoing Ylc(n) and Yel(n) are combined, an output signal Y(n) is obtained, and a signal bandwidth of the output signal Y(n) includes two partial frequency bands: LF and HFnew. An encoding/decoding performance of Y(n) is better than that of Ylc(n).

The following describes a processing of combining the enhancement layer signal and the compatible layer signal. A frequency domain expression of the signal Ylc(n) is Ylc(k), where k=0, 1, 2, 3, . . . , or M. A frequency domain expression of the signal Yel(n) is Yel(k), where k=0, 1, 2, 3, . . . , or V. In this case, a frequency domain expression of the signal Y(n) is Y(k), where k=0, 1, 2, 3, . . . , or M:

Y(k)=Ylc(k), where k=0,1,2, . . . , or M−V; and

Y(k)=Ylc(k)*H1(k−M+V−1)+Yel(k−M+V−1)*H2(k−M+V−1), where k=M−V+1,M−V+2, . . . , or M.

H1(.) and H2(.) are respectively an adaptation function of the compatible layer signal and an adaptation function of the enhancement layer signal.

Decoding of the harmonic signal is used as an example. The decoder side reconstructs a corresponding harmonic component Yel(k) based on a fundamental frequency, a harmonic quantity, and an amplitude. If enhancement layer base energy is EnerNF, and envelope energy that is output by the compatible layer is EnerENV, the foregoing two adaptation functions are as follows: H1(k)=EnerNF/EnerENV, and H2(k)=1.

The output signal Y(k) is:

Y(k)=Ylc(k), where k=0,1,2, . . . , or M−V; and

Y(k)=Ylc(k)*EnerNF/EnerENV+Yel(k−M+V−1), where k=M−V+1,M−V+2, . . . , or M.

Finally, Y(k) is converted into a time domain signal Y(t) as the final output signal.

In the foregoing audio encoding and decoding procedure provided in embodiments of this application, one audio encoding and decoding system includes one compatible layer and one enhancement layer. The compatible layer can completely implement an audio encoding and decoding function, and a generated bitstream is fully compatible with an old encoding and decoding system. The compatible layer in this embodiment is fully backward-compatible with an old codec. In this embodiment, the enhancement layer encodes/decodes a signal of a preset signal type based on a signal classification parameter, and a final output signal is obtained after a decoder side combines an enhancement layer signal and a compatible layer signal based on the signal classification parameter. The enhancement layer can encode/decode some spectrums of the input audio signal. The decoder side determines, based on information about the enhancement layer, whether to use a decoded audio signal that is output by the compatible layer as a final decoded output signal, or to first combine a decoded output of the enhancement layer and a decoded output of the compatible layer, and then use a combined signal as a final decoded output signal. The compatible layer and the audio encoding and decoding system have a same input signal, and the compatible layer encodes/decodes all spectrum components of the input signal.

In this embodiment, the signal classifier performs enhanced encoding on the signal of the preset signal type by using the enhancement layer. The overall output signal of the decoder is obtained by combining the enhancement layer signal and the compatible layer signal. Encoding/decoding performance of the overall output signal of the decoder is better than encoding/decoding performance of a signal directly output through compatible layer encoding/decoding.

It should be noted that, for brief description, the foregoing method embodiments are represented as a series of actions. However, a person skilled in the art should appreciate that this application is not limited to the described order of the actions, because according to this application, some steps may be performed in other orders or simultaneously. In addition, it should be further appreciated by a person skilled in the art that the embodiments described in this specification all belong to example embodiments, and the involved actions and modules are not necessarily required by this application.

To better implement the foregoing solutions in embodiments of this application, the following further provides a related apparatus for implementing the foregoing solutions.

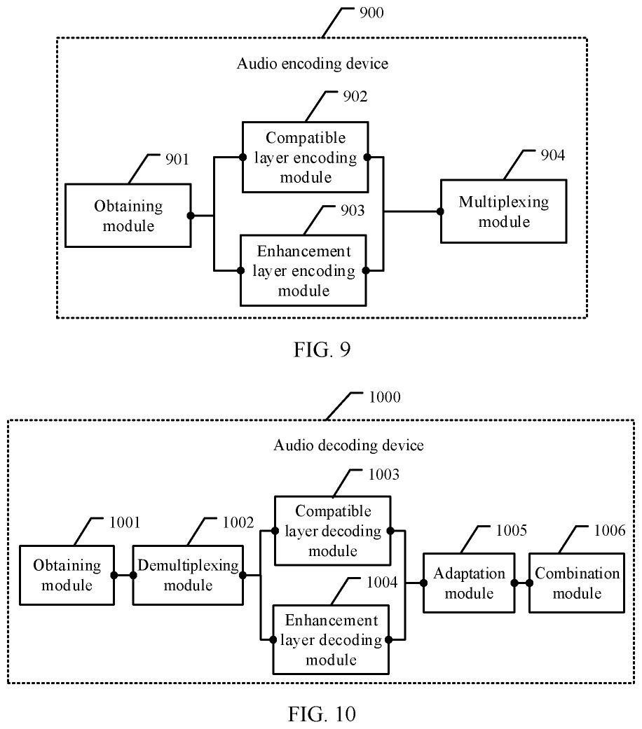

As shown in FIG. 9, an audio encoding device 900 provided in an embodiment of this application may include an obtaining module 901, a compatible layer encoding module 902, an enhancement layer encoding module 903, and a multiplexing module 904.

The obtaining module is configured to obtain a current frame of an audio signal, where the current frame includes a high frequency band signal and a low frequency band signal.

The compatible layer encoding module is configured to obtain a compatible layer encoding parameter of the current frame based on the high frequency band signal and the low frequency band signal.

The enhancement layer encoding module is configured to obtain an enhancement layer encoding parameter of the current frame based on the high frequency band signal.

The multiplexing module is configured to perform bitstream multiplexing on the compatible layer encoding parameter and the enhancement layer encoding parameter to obtain an encoded bitstream.

In some embodiments of this application, the enhancement layer encoding module is configured to: obtain signal type information of the high frequency band signal of the current frame; and encode the high frequency band signal of the current frame when the signal type information of the high frequency band signal of the current frame indicates a preset signal type, to obtain the enhancement layer encoding parameter of the current frame.

In some embodiments of this application, the preset signal type includes at least one of the following: a harmonic signal type, a tonal signal type, a white noise-like signal type, a transient signal type, or a fricative signal type.

In some embodiments of this application, the enhancement layer encoding parameter of the current frame further includes the signal type information of the high frequency band signal of the current frame.

In some embodiments of this application, the enhancement layer encoding module is configured to: obtain compatible layer encoding frequency band information; determine a to-be-encoded frequency band signal in the high frequency band signal of the current frame based on the compatible layer encoding frequency band information; and encode the to-be-encoded frequency band signal to obtain the enhancement layer encoding parameter.

It can be learned from the example description of the encoding method in this application in the foregoing embodiment that the current frame of the audio signal is obtained, where the current frame includes the high frequency band signal and the low frequency band signal; the compatible layer encoding parameter of the current frame is obtained based on the high frequency band signal and the low frequency band signal; the enhancement layer encoding parameter of the current frame is obtained based on the high frequency band signal; and bitstream multiplexing is performed on the compatible layer encoding parameter and the enhancement layer encoding parameter to obtain the encoded bitstream. In this embodiment of this application, all frequency domain ranges for encoding the audio signal may be included at the compatible layer, but only a high frequency domain range for encoding the audio signal is included at the enhancement layer. The compatible layer may be implemented by using an old audio encoding device, and the enhancement layer and the compatible layer may be implemented by using a new audio encoding device. Therefore, in this embodiment of this application, the new audio encoding device is compatible with the old audio encoding device. According to a device type of the audio encoding device, encoding may be performed at only the compatible layer, or at both the compatible layer and the enhancement layer. In this embodiment of this application, no new transcoding module needs to be added to the old audio encoding device. Therefore, upgrade costs of the audio encoding device are reduced, and audio signal encoding efficiency can be improved.

As shown in FIG. 10, an audio decoding device 1000 provided in an embodiment of this application may include an obtaining module 1001, a demultiplexing module 1002, a compatible layer decoding module 1003, an enhancement layer decoding module 1004, an adaptation module 1005, and a combination module 1006.

The obtaining module is configured to obtain an encoded bitstream.

The demultiplexing module is configured to perform bitstream demultiplexing on the encoded bitstream to obtain a compatible layer encoding parameter of a current frame of an audio signal and an enhancement layer encoding parameter of the current frame.

The compatible layer decoding module is configured to obtain a compatible layer signal of the current frame based on the compatible layer encoding parameter, where the compatible layer signal includes a first high frequency band signal of the current frame and a first low frequency band signal of the current frame.

The enhancement layer decoding module is configured to obtain an enhancement layer signal of the current frame based on the enhancement layer encoding parameter.

The adaptation module is configured to adapt the first high frequency band signal of the current frame based on the enhancement layer encoding parameter or the enhancement layer signal of the current frame, to obtain a second high frequency band signal of the current frame.

The combination module is configured to obtain an audio output signal of the current frame based on the enhancement layer signal of the current frame, the second high frequency band signal of the current frame, and the first low frequency band signal of the current frame.

In some embodiments of this application, the enhancement layer decoding module is configured to: obtain signal type information based on the enhancement layer encoding parameter of the current frame; and decode the enhancement layer encoding parameter of the current frame based on a preset signal type indicated by the signal type information, to obtain the enhancement layer signal of the current frame.

In some embodiments of this application, the adaptation module is configured to: obtain a compatible layer high frequency band adjustment parameter based on the enhancement layer encoding parameter or the enhancement layer signal of the current frame and the first high frequency band signal of the current frame; and adapt the first high frequency band signal of the current frame by using the compatible layer high frequency band adjustment parameter, to obtain the second high frequency band signal of the current frame.

In some embodiments of this application, the adaptation module is configured to: obtain envelope information corresponding to the enhancement layer encoding parameter or the enhancement layer signal of the current frame, and obtain envelope information of the first high frequency band signal of the current frame; and obtain the compatible layer high frequency band adjustment parameter based on the envelope information corresponding to the enhancement layer encoding parameter or the enhancement layer signal and the envelope information of the first high frequency band signal.

In some embodiments of this application, the adaptation module is configured to: select an enhancement layer high frequency band spectrum signal of the current frame from the enhancement layer signal of the current frame according to a preset high frequency band spectrum selection rule; and combine the enhancement layer high frequency band spectrum signal and the first high frequency band signal of the current frame, to obtain the second high frequency band signal of the current frame.

In some embodiments of this application, the adaptation module is configured to: obtain a compatible layer decoded signal and a compatible layer bandwidth extension signal that are included in the first high frequency band signal of the current frame; and determine, as the enhancement layer high frequency band spectrum signal of the current frame, a signal that is in the enhancement layer signal of the current frame and that corresponds to the compatible layer bandwidth extension signal.

In some embodiments of this application, the adaptation module is configured to replace the first high frequency band signal of the current frame with the enhancement layer signal of the current frame, to obtain the second high frequency band signal of the current frame.

In some embodiments of this application, the adaptation module is configured to: obtain an enhancement layer high frequency band adjustment parameter based on the enhancement layer encoding parameter or the enhancement layer signal of the current frame and the first high frequency band signal of the current frame; adapt the enhancement layer signal of the current frame by using the enhancement layer high frequency band adjustment parameter, to obtain an adapted enhancement layer signal; and replace the first high frequency band signal of the current frame with the adapted enhancement layer signal, to obtain the second high frequency band signal of the current frame.

In some embodiments of this application, the adaptation module is configured to: obtain an enhancement layer high frequency band adjustment parameter based on the enhancement layer encoding parameter or the enhancement layer signal of the current frame and the first high frequency band signal of the current frame; replace the first high frequency band signal of the current frame with the enhancement layer signal of the current frame, to obtain a first high frequency band signal generated after the replacement; and adapt, by using the enhancement layer high frequency band adjustment parameter, the first high frequency band signal generated after the replacement, to obtain the second high frequency band signal of the current frame.

In some embodiments of this application, the adaptation module is configured to: perform spectrum component comparison selection on the enhancement layer signal of the current frame and the first high frequency band signal of the current frame, to select a first enhancement layer sub-signal from the enhancement layer signal of the current frame; and replace, with the first enhancement layer sub-signal, a signal that is in the first high frequency band signal of the current frame and that has a same spectrum as the first enhancement layer sub-signal, to obtain the second high frequency band signal of the current frame.

In some embodiments of this application, the enhancement layer decoding module is configured to: determine a to-be-decoded enhancement layer high frequency band signal in the enhancement layer encoding parameter based on the enhancement layer encoding parameter and the compatible layer encoding parameter; and decode the to-be-decoded enhancement layer high frequency band signal in the enhancement layer encoding parameter, to obtain the enhancement layer signal of the current frame.

In some embodiments of this application, the adaptation module is configured to: obtain a compatible layer decoded signal and a compatible layer bandwidth extension signal in the compatible layer signal of the current frame; and combine the compatible layer bandwidth extension signal and the enhancement layer signal of the current frame, to obtain the second high frequency band signal of the current frame.

In some embodiments of this application, a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY].

FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

Alternatively, FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal.

Alternatively, FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

In some embodiments of this application, the audio decoding device 1000 may further include a post-processing module, configured to post-process the audio output signal of the current frame after the combination module obtains the audio output signal of the current frame based on the enhancement layer signal of the current frame, the second high frequency band signal of the current frame, and the first low frequency band signal of the current frame.

In some embodiments of this application, the audio decoding device 1000 may further include a post-processing module, configured to: before the combination module obtains the audio output signal of the current frame based on the enhancement layer signal of the current frame, the second high frequency band signal of the current frame, and the first low frequency band signal of the current frame, obtain a post-processing parameter based on the compatible layer signal; and post-process the enhancement layer signal by using the post-processing parameter, to obtain a post-processed enhancement layer signal.

It can be learned from the example description of the decoding method in this application in the foregoing embodiment that the encoded bitstream is obtained; bitstream demultiplexing is performed on the encoded bitstream to obtain the compatible layer encoding parameter of the current frame of the audio signal and the enhancement layer encoding parameter of the current frame; the compatible layer signal of the current frame is obtained based on the compatible layer encoding parameter, where the compatible layer signal includes the first high frequency band signal of the current frame and the first low frequency band signal of the current frame; the enhancement layer signal of the current frame is obtained based on the enhancement layer encoding parameter; the first high frequency band signal of the current frame is adapted based on the enhancement layer encoding parameter or the enhancement layer signal of the current frame, to obtain the second high frequency band signal of the current frame; and the audio output signal of the current frame is obtained based on the enhancement layer signal of the current frame, the second high frequency band signal of the current frame, and the first low frequency band signal of the current frame. In this embodiment of this application, all frequency domain ranges for decoding the audio signal may be included at a compatible layer, but only a high frequency domain range for decoding the audio signal is included at an enhancement layer. The compatible layer may be implemented by using an old audio decoding device, and the enhancement layer and the compatible layer may be implemented by using a new audio decoding device. Therefore, in this embodiment of this application, the new audio decoding device is compatible with the old audio decoding device. According to a device type of the audio decoding device, decoding may be performed at only the compatible layer, or at both the compatible layer and the enhancement layer. In this embodiment of this application, no new transcoding module needs to be added to the old audio decoding device. Therefore, upgrade costs of the audio decoding device are reduced, and audio signal decoding efficiency can be improved.

As shown in FIG. 11, an embodiment of this application further provides an audio encoding device, and the audio encoding device 1100 includes a compatible layer encoder 1101, an enhancement layer encoder 1102, and a bitstream multiplexer 1103.

The compatible layer encoder is configured to: obtain a current frame of an audio signal, where the current frame includes a high frequency band signal and a low frequency band signal; and obtain a compatible layer encoding parameter of the current frame based on the high frequency band signal and the low frequency band signal.

The enhancement layer encoder is configured to: obtain the current frame of the audio signal, where the current frame includes the high frequency band signal and the low frequency band signal; and obtain an enhancement layer encoding parameter of the current frame based on the high frequency band signal.

The bitstream multiplexer is configured to perform bitstream multiplexing on the compatible layer encoding parameter and the enhancement layer encoding parameter to obtain an encoded bitstream.

Specifically, the audio encoding device may perform the foregoing audio encoding method shown in FIG. 2. For details, refer to the example description of the audio encoding method in the foregoing embodiment. Details are not described herein again.

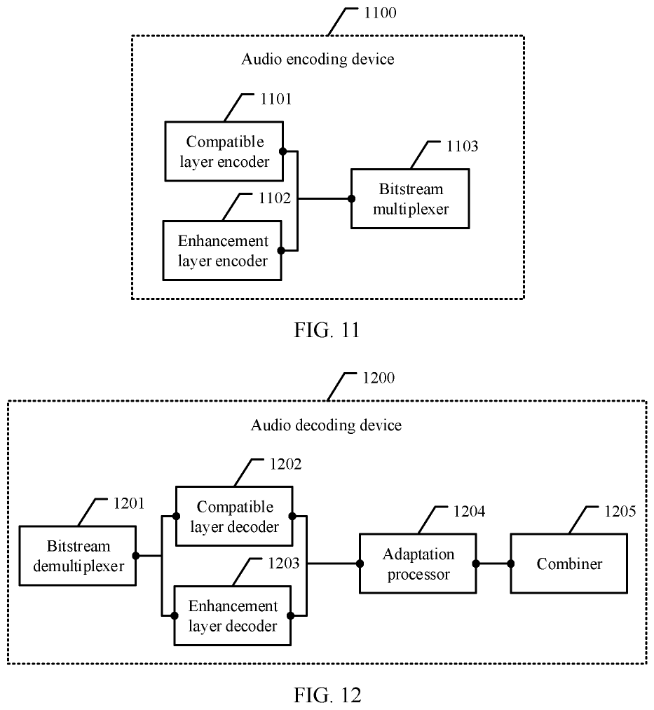

As shown in FIG. 12, an embodiment of this application further provides an audio decoding device, and the audio decoding device 1200 includes a bitstream demultiplexer 1201, a compatible layer decoder 1202, an enhancement layer decoder 1203, an adaptation processor 1204, and a combiner 1205.

The bitstream demultiplexer is configured to: obtain an encoded bitstream; and perform bitstream demultiplexing on the encoded bitstream to obtain a compatible layer encoding parameter of a current frame of an audio signal and an enhancement layer encoding parameter of the current frame.

The compatible layer decoder is configured to obtain a compatible layer signal of the current frame based on the compatible layer encoding parameter, where the compatible layer signal includes a first high frequency band signal of the current frame and a first low frequency band signal of the current frame.

The enhancement layer decoder is configured to obtain an enhancement layer signal of the current frame based on the enhancement layer encoding parameter.

The adaptation processor is configured to adapt the first high frequency band signal of the current frame based on the enhancement layer encoding parameter or the enhancement layer signal of the current frame, to obtain a second high frequency band signal of the current frame.

The combiner is configured to obtain an audio output signal of the current frame based on the enhancement layer signal of the current frame, the second high frequency band signal of the current frame, and the first low frequency band signal of the current frame.

Specifically, the audio decoding device may perform the foregoing audio decoding method shown in FIG. 3. For details, refer to the example description of the audio decoding method in the foregoing embodiment. Details are not described herein again.

It should be noted that content such as information exchange between the modules/units of the apparatus and the execution processes thereof is based on a same concept as the method embodiments of this application, and achieves same technical effects as the method embodiments of this application. For specific content, refer to the foregoing description in the method embodiments of this application. Details are not described herein again.

An embodiment of this application further provides a computer storage medium. The computer storage medium stores a program. The program is executed to perform some or all of the steps recorded in the method embodiments.

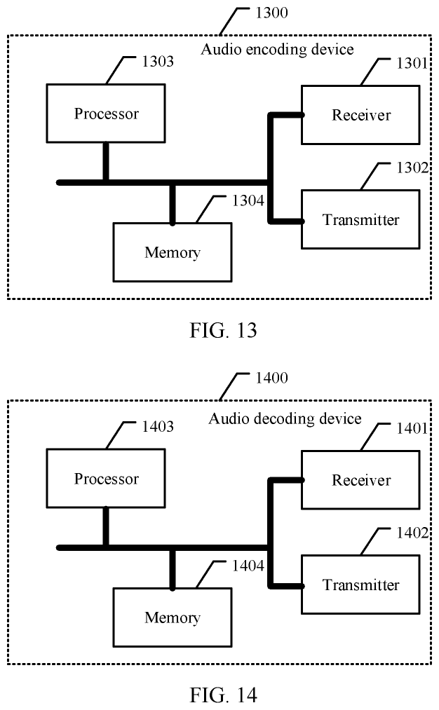

The following describes another audio encoding device provided in an embodiment of this application. As shown in FIG. 13, an audio encoding device 1300 includes:

a receiver 1301, a transmitter 1302, a processor 1303, and a memory 1304 (where there may be one or more processors 1303 in the audio encoding device 1300, and one processor is used as an example in FIG. 13). In some embodiments of this application, the receiver 1301, the transmitter 1302, the processor 1303, and the memory 1304 may be connected through a bus or in another manner. In FIG. 13, a connection through a bus is used as an example.

The memory 1304 may include a read-only memory and a random access memory, and provide instructions and data to the processor 1303. Apart of the memory 1304 may further include a non-volatile random access memory (non-volatile random access memory, NVRAM). The memory 1304 stores an operating system and operation instructions, an executable module or a data structure, a subset thereof, or an extended set thereof. The operation instructions may include various operation instructions to implement various operations. The operating system may include various system programs, to implement various basic services and process hardware-based tasks.

The processor 1303 controls an operation of the audio encoding device, and the processor 1303 may further be referred to as a central processing unit (central processing unit, CPU). In specific application, components of the audio encoding device are coupled together through a bus system. In addition to a data bus, the bus system may further include a power bus, a control bus, a status signal bus, and the like. However, for clear description, various types of buses in the figure are marked as the bus system.

The method disclosed in the foregoing embodiments of this application may be applied to the processor 1303, or may be implemented by the processor 1303. The processor 1303 may be an integrated circuit chip and has a signal processing capability. In an implementation process, steps in the foregoing methods can be implemented by using a hardware integrated logic circuit in the processor 1303, or by using instructions in a form of software. The processor 1303 may be a general-purpose processor, a digital signal processor (digital signal processing, DSP), an application-specific integrated circuit (application-specific integrated circuit, ASIC), a field-programmable gate array (field-programmable gate array, FPGA) or another programmable logic device, a discrete gate or transistor logic device, or a discrete hardware component. The processor may implement or perform the method, steps, and logic block diagrams that are disclosed in embodiments of this application. The general-purpose processor may be a microprocessor, or the processor may be any conventional processor or the like. The steps of the methods disclosed with reference to embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory 1304, and the processor 1303 reads information in the memory 1304 and completes the steps in the foregoing methods in combination with hardware of the processor.

The receiver 1301 may be configured to receive entered digital or character information, and generate signal input related to related settings and function control of the audio encoding device. The transmitter 1302 may include a display device such as a display, and the transmitter 1302 may be configured to output digital or character information through an external interface.

In this embodiment of this application, the processor 1303 is configured to perform the audio encoding method shown in FIG. 2.

The following describes another audio decoding device provided in an embodiment of this application. As shown in FIG. 14, an audio decoding device 1400 includes:

a receiver 1401, a transmitter 1402, a processor 1403, and a memory 1404 (where there may be one or more processors 1403 in the audio decoding device 1400, and one processor is used as an example in FIG. 14). In some embodiments of this application, the receiver 1401, the transmitter 1402, the processor 1403, and the memory 1404 may be connected through a bus or in another manner, and a connection through the bus is used as an example in FIG. 14.

The memory 1404 may include a read-only memory and a random access memory, and provide instructions and data to the processor 1403. Apart of the memory 1404 may further include an NVRAM. The memory 1404 stores an operating system and operation instructions, an executable module or a data structure, a subset thereof, or an extended set thereof. The operation instructions may include various operation instructions to implement various operations. The operating system may include various system programs, to implement various basic services and process hardware-based tasks.

The processor 1403 controls an operation of the audio decoding device, and the processor 1403 may further be referred to as a CPU. In specific application, components of the audio decoding device are coupled together through a bus system. In addition to a data bus, the bus system may further include a power bus, a control bus, a status signal bus, and the like. However, for clear description, various types of buses in the figure are marked as the bus system.

The methods disclosed in embodiments of this application may be applied to the processor 1403 or may be implemented by the processor 1403. The processor 1403 may be an integrated circuit chip and has a signal processing capability. In an implementation process, steps in the foregoing methods can be implemented by using a hardware integrated logic circuit in the processor 1403, or by using instructions in a form of software. The foregoing processor 1403 may be a general-purpose processor, a DSP, an ASIC, an FPGA or another programmable logic device, a discrete gate or transistor logic device, or a discrete hardware component. The processor may implement or perform the method, steps, and logic block diagrams that are disclosed in embodiments of this application. The general-purpose processor may be a microprocessor, or the processor may be any conventional processor or the like. The steps of the methods disclosed with reference to embodiments of this application may be directly performed and completed by a hardware decoding processor, or may be performed and completed by using a combination of hardware and software modules in the decoding processor. The software module may be located in a mature storage medium in the art, such as a random access memory, a flash memory, a read-only memory, a programmable read-only memory, an electrically erasable programmable memory, or a register. The storage medium is located in the memory 1404, and the processor 1403 reads information in the memory 1404 and completes the steps in the foregoing methods in combination with hardware of the processor 1403.

In this embodiment of this application, the processor 1403 is configured to perform the audio decoding method shown in FIG. 3.

In another possible design, when the audio encoding device or the audio decoding device is a chip in a terminal, the chip includes a processing unit and a communications unit. The processing unit may be, for example, a processor, and the communications unit may be, for example, an input/output interface, a pin, or a circuit. The processing unit may execute computer-executable instructions stored in a storage unit, to enable the chip in the terminal to perform the method according to any one of the possible implementations of the first aspect. Optionally, the storage unit is a storage unit in the chip, for example, a register or a cache. Alternatively, the storage unit may be a storage unit that is in the terminal and that is located outside the chip, for example, a read-only memory (read-only memory, ROM) or another type of static storage device that may store static information and instructions, for example, a random access memory (random access memory, RAM).

The processor mentioned anywhere above may be a general-purpose central processing unit, a microprocessor, an ASIC, or one or more integrated circuits configured to control program execution of the method according to the first aspect.

In addition, it should be noted that the described apparatus embodiments are merely examples. The units described as separate parts may or may not be physically separate, and parts displayed as units may or may not be physical units, and may be located in one position, or may be distributed on a plurality of network units. Some or all the modules may be selected according to an actual need to achieve the objectives of the solutions of the embodiments. In addition, in the accompanying drawings of the apparatus embodiments provided in this application, connection relationships between modules indicate that the modules have communication connections with each other, which may be specifically implemented as one or more communications buses or signal cables.

Based on the descriptions of the foregoing implementations, a person skilled in the art may clearly understand that this application may be implemented by software in addition to necessary universal hardware, or certainly may be implemented by dedicated hardware, including an application-specific integrated circuit, a dedicated CPU, a dedicated memory, a dedicated component, and the like. Generally, any functions that can be performed by a computer program can be easily implemented by using corresponding hardware, and a specific hardware structure used to achieve a same function may be of various forms, for example, in a form of an analog circuit, a digital circuit, or a dedicated circuit. However, in this application, a software program implementation is a better implementation in most cases. Based on such an understanding, the technical solutions of this application essentially or the part contributing to the conventional technology may be implemented in a form of a software product. The computer software product is stored in a readable storage medium, for example, a floppy disk, a USB flash drive, a removable hard disk, a ROM, a RAM, a magnetic disk, or a compact disc of a computer, and includes several instructions for instructing a computer device (which may be a personal computer, a server, a network device, or the like) to perform the methods described in embodiments of this application.

All or some of the foregoing embodiments may be implemented by using software, hardware, firmware, or any combination thereof. When software is used to implement the embodiments, all or some of the embodiments may be implemented in a form of a computer program product.

The computer program product includes one or more computer instructions. When the computer program instructions are loaded and executed on a computer, all or some of the procedures or the functions according to embodiments of this application are generated. The computer may be a general purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk or a magnetic tape), an optical medium (for example, a DVD), a semiconductor medium (for example, a solid state disk (Solid State Disk, SSD)), or the like.

What is claimed is:

1. An audio encoding method, comprising:
obtaining a current frame of an audio signal, wherein the current frame comprises a high frequency band signal and a low frequency band signal;
obtaining a compatible layer encoding parameter of the current frame based on the high frequency band signal and the low frequency band signal;
obtaining an enhancement layer encoding parameter of the current frame based on the high frequency band signal;
performing bitstream multiplexing on the compatible layer encoding parameter and the enhancement layer encoding parameter to obtain an encoded bitstream; and
sending or storing the encoded bitstream.

2. The audio encoding method according to claim 1, wherein the obtaining the enhancement layer encoding parameter of the current frame based on the high frequency band signal comprises:
obtaining signal type information of the high frequency band signal of the current frame; and
encoding the high frequency band signal of the current frame when the signal type information of the high frequency band signal of the current frame indicates a preset signal type, to obtain the enhancement layer encoding parameter of the current frame.

3. The audio encoding method according to claim 2, wherein the preset signal type comprises at least one of the following: a harmonic signal type, a tonal signal type, a white noise-like signal type, a transient signal type, or a fricative signal type.

4. The audio encoding method according to claim 2, wherein the enhancement layer encoding parameter of the current frame further comprises the signal type information of the high frequency band signal of the current frame.

5. The audio encoding method according to claim 1, wherein the obtaining the enhancement layer encoding parameter of the current frame based on the high frequency band signal comprises:
obtaining compatible layer encoding frequency band information;
determining a to-be-encoded frequency band signal in the high frequency band signal of the current frame based on the compatible layer encoding frequency band information; and
encoding the to-be-encoded frequency band signal to obtain the enhancement layer encoding parameter.

6. An audio decoding method, comprising:
obtaining an encoded bitstream;
performing bitstream demultiplexing on the encoded bitstream to obtain a compatible layer encoding parameter of a current frame of an audio signal and an enhancement layer encoding parameter of the current frame;
obtaining a compatible layer signal of the current frame based on the compatible layer encoding parameter, wherein the compatible layer signal comprises a first high frequency band signal of the current frame and a first low frequency band signal of the current frame;
obtaining an enhancement layer signal of the current frame based on the enhancement layer encoding parameter;
adapting the first high frequency band signal of the current frame based on the enhancement layer encoding parameter or the enhancement layer signal of the current frame, to obtain a second high frequency band signal of the current frame;
obtaining an audio output signal of the current frame based on the enhancement layer signal of the current frame, the second high frequency band signal of the current frame, and the first low frequency band signal of the current frame; and
playing back or outputting the audio output signal.

7. The audio decoding method according to claim 6, wherein the obtaining the enhancement layer signal of the current frame based on the enhancement layer encoding parameter comprises:
obtaining signal type information based on the enhancement layer encoding parameter of the current frame; and
decoding the enhancement layer encoding parameter of the current frame based on a preset signal type indicated by the signal type information, to obtain the enhancement layer signal of the current frame.

8. The audio decoding method according to claim 6, wherein the adapting the first high frequency band signal of the current frame based on the enhancement layer encoding parameter or the enhancement layer signal of the current frame, to obtain the second high frequency band signal of the current frame comprises one of the following:
(i) obtaining a compatible layer high frequency band adjustment parameter based on the enhancement layer encoding parameter or the enhancement layer signal of the current frame and the first high frequency band signal of the current frame; and
adapting the first high frequency band signal of the current frame by using the compatible layer high frequency band adjustment parameter, to obtain the second high frequency band signal of the current frame;
(ii) selecting an enhancement layer high frequency band spectrum signal of the current frame from the enhancement layer signal of the current frame according to a preset high frequency band spectrum selection rule; and
combining the enhancement layer high frequency band spectrum signal and the first high frequency band signal of the current frame, to obtain the second high frequency band signal of the current frame;
(iii) replacing the first high frequency band signal of the current frame with the enhancement layer signal of the current frame, to obtain the second high frequency band signal of the current frame; or
(iv) obtaining a compatible layer decoded signal and a compatible layer bandwidth extension signal in the compatible layer signal of the current frame; and
combining the compatible layer bandwidth extension signal and the enhancement layer signal of the current frame, to obtain the second high frequency band signal of the current frame.

9. The audio decoding method according to claim 8, wherein the adapting the first high frequency band signal of the current frame based on the enhancement layer encoding parameter or the enhancement layer signal of the current frame, to obtain the second high frequency band signal of the current frame comprises obtaining the compatible layer high frequency band adjustment parameter based on the enhancement layer encoding parameter or the enhancement layer signal of the current frame and the first high frequency band signal of the current frame, and
wherein the obtaining the compatible layer high frequency band adjustment parameter based on the enhancement layer encoding parameter or the enhancement layer signal of the current frame and the first high frequency band signal of the current frame comprises:
obtaining envelope information corresponding to the enhancement layer encoding parameter or the enhancement layer signal of the current frame, and obtaining envelope information of the first high frequency band signal of the current frame; and
obtaining the compatible layer high frequency band adjustment parameter based on the envelope information corresponding to the enhancement layer encoding parameter or the enhancement layer signal and the envelope information of the first high frequency band signal.

10. The audio decoding method according to claim 8, wherein the adapting the first high frequency band signal of the current frame based on the enhancement layer encoding parameter or the enhancement layer signal of the current frame, to obtain the second high frequency band signal of the current frame comprises selecting the enhancement layer high frequency band spectrum signal of the current frame from the enhancement layer signal of the current frame according to a preset high frequency band spectrum selection rule, and
wherein the selecting the enhancement layer high frequency band spectrum signal of the current frame from the enhancement layer signal of the current frame according to a preset high frequency band spectrum selection rule comprises:
obtaining a compatible layer decoded signal and a compatible layer bandwidth extension signal that are comprised in the first high frequency band signal of the current frame; and
determining, as the enhancement layer high frequency band spectrum signal of the current frame, a signal that is in the enhancement layer signal of the current frame and that corresponds to the compatible layer bandwidth extension signal.

11. The audio decoding method according to claim 8, wherein the adapting the first high frequency band signal of the current frame based on the enhancement layer encoding parameter or the enhancement layer signal of the current frame, to obtain the second high frequency band signal of the current frame comprises replacing the first high frequency band signal of the current frame with the enhancement layer signal of the current frame, to obtain the second high frequency band signal of the current frame, and
wherein the replacing the first high frequency band signal of the current frame with the enhancement layer signal of the current frame, to obtain the second high frequency band signal of the current frame comprises one of the following:
(i) obtaining an enhancement layer high frequency band adjustment parameter based on the enhancement layer encoding parameter or the enhancement layer signal of the current frame and the first high frequency band signal of the current frame;
adapting the enhancement layer signal of the current frame by using the enhancement layer high frequency band adjustment parameter, to obtain an adapted enhancement layer signal; and
replacing the first high frequency band signal of the current frame with the adapted enhancement layer signal, to obtain the second high frequency band signal of the current frame;
(ii) obtaining an enhancement layer high frequency band adjustment parameter based on the enhancement layer encoding parameter or the enhancement layer signal of the current frame and the first high frequency band signal of the current frame;
replacing the first high frequency band signal of the current frame with the enhancement layer signal of the current frame, to obtain a first high frequency band signal generated after the replacement; and
adapting, by using the enhancement layer high frequency band adjustment parameter, the first high frequency band signal generated after the replacement, to obtain the second high frequency band signal of the current frame; or
(iii) performing spectrum component comparison selection on the enhancement layer signal of the current frame and the first high frequency band signal of the current frame, to select a first enhancement layer sub-signal from the enhancement layer signal of the current frame; and
replacing, with the first enhancement layer sub-signal, a signal that is in the first high frequency band signal of the current frame and that has a same spectrum as the first enhancement layer sub-signal, to obtain the second high frequency band signal of the current frame.

12. The audio decoding method according to claim 6, wherein the obtaining the enhancement layer signal of the current frame based on the enhancement layer encoding parameter comprises:
determining a to-be-decoded enhancement layer high frequency band signal in the enhancement layer encoding parameter based on the enhancement layer encoding parameter and the compatible layer encoding parameter; and
decoding the to-be-decoded enhancement layer high frequency band signal in the enhancement layer encoding parameter, to obtain the enhancement layer signal of the current frame.

13. The audio decoding method according to claim 8, wherein a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY]; and
FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or
FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal; or
FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or
FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.

14. An audio decoding apparatus, comprising:
at least one processor; and
one or more memories coupled to the at least one processor and storing programming instructions for execution by the at least one processor to cause the audio decoding apparatus to:
obtain an encoded bitstream;
perform bitstream demultiplexing on the encoded bitstream to obtain a compatible layer encoding parameter of a current frame of an audio signal and an enhancement layer encoding parameter of the current frame;
obtain a compatible layer signal of the current frame based on the compatible layer encoding parameter, wherein the compatible layer signal comprises a first high frequency band signal of the current frame and a first low frequency band signal of the current frame;
obtain an enhancement layer signal of the current frame based on the enhancement layer encoding parameter;
adapt the first high frequency band signal of the current frame based on the enhancement layer encoding parameter or the enhancement layer signal of the current frame, to obtain a second high frequency band signal of the current frame; and
obtain an audio output signal of the current frame based on the enhancement layer signal of the current frame, the second high frequency band signal of the current frame, and the first low frequency band signal of the current frame.

15. The audio decoding apparatus according to claim 14, wherein the programming instructions for execution by the at least one processor to cause the audio decoding apparatus further to:
obtaining signal type information based on the enhancement layer encoding parameter of the current frame; and
decoding the enhancement layer encoding parameter of the current frame based on a preset signal type indicated by the signal type information, to obtain the enhancement layer signal of the current frame.

16. The audio decoding apparatus according to claim 14, wherein the programming instructions for execution by the at least one processor to cause the audio decoding apparatus further to be capable of any of:
(i) obtain a compatible layer high frequency band adjustment parameter based on the enhancement layer encoding parameter or the enhancement layer signal of the current frame and the first high frequency band signal of the current frame; and
adapt the first high frequency band signal of the current frame by using the compatible layer high frequency band adjustment parameter, to obtain the second high frequency band signal of the current frame;
(ii) select an enhancement layer high frequency band spectrum signal of the current frame from the enhancement layer signal of the current frame according to a preset high frequency band spectrum selection rule; and
combine the enhancement layer high frequency band spectrum signal and the first high frequency band signal of the current frame, to obtain the second high frequency band signal of the current frame;
(iii) replace the first high frequency band signal of the current frame with the enhancement layer signal of the current frame, to obtain the second high frequency band signal of the current frame; and
(iv) obtain a compatible layer decoded signal and a compatible layer bandwidth extension signal in the compatible layer signal of the current frame; and
combine the compatible layer bandwidth extension signal and the enhancement layer signal of the current frame, to obtain the second high frequency band signal of the current frame.

17. The audio decoding apparatus according to claim 16, wherein the programming instructions for execution by the at least one processor to cause the audio decoding apparatus further to:
obtain envelope information corresponding to the enhancement layer encoding parameter or the enhancement layer signal of the current frame, and obtaining envelope information of the first high frequency band signal of the current frame; and
obtain the compatible layer high frequency band adjustment parameter based on the envelope information corresponding to the enhancement layer encoding parameter or the enhancement layer signal and the envelope information of the first high frequency band signal.

18. The audio decoding apparatus according to claim 16, wherein the programming instructions for execution by the at least one processor to cause the audio decoding apparatus further to:
obtain a compatible layer decoded signal and a compatible layer bandwidth extension signal that are comprised in the first high frequency band signal of the current frame; and
determine, as the enhancement layer high frequency band spectrum signal of the current frame, a signal that is in the enhancement layer signal of the current frame and that corresponds to the compatible layer bandwidth extension signal.

19. The audio decoding apparatus according to claim 16, wherein the programming instructions for execution by the at least one processor to cause the audio decoding apparatus further to be capable of any of:
(i) obtain an enhancement layer high frequency band adjustment parameter based on the enhancement layer encoding parameter or the enhancement layer signal of the current frame and the first high frequency band signal of the current frame;
adapt the enhancement layer signal of the current frame by using the enhancement layer high frequency band adjustment parameter, to obtain an adapted enhancement layer signal; and
replace the first high frequency band signal of the current frame with the adapted enhancement layer signal, to obtain the second high frequency band signal of the current frame;
(ii) obtain an enhancement layer high frequency band adjustment parameter based on the enhancement layer encoding parameter or the enhancement layer signal of the current frame and the first high frequency band signal of the current frame;
replace the first high frequency band signal of the current frame with the enhancement layer signal of the current frame, to obtain a first high frequency band signal generated after the replacement; and
adapt, by using the enhancement layer high frequency band adjustment parameter, the first high frequency band signal generated after the replacement, to obtain the second high frequency band signal of the current frame; and
(iii) perform spectrum component comparison selection on the enhancement layer signal of the current frame and the first high frequency band signal of the current frame, to select a first enhancement layer sub-signal from the enhancement layer signal of the current frame; and
replace, with the first enhancement layer sub-signal, a signal that is in the first high frequency band signal of the current frame and that has a same spectrum as the first enhancement layer sub-signal, to obtain the second high frequency band signal of the current frame.

20. The audio decoding apparatus according to claim 14, wherein the programming instructions for execution by the at least one processor to cause the audio decoding apparatus further to:
determine a to-be-decoded enhancement layer high frequency band signal in the enhancement layer encoding parameter based on the enhancement layer encoding parameter and the compatible layer encoding parameter; and
decode the to-be-decoded enhancement layer high frequency band signal in the enhancement layer encoding parameter, to obtain the enhancement layer signal of the current frame.

21. The audio decoding apparatus according to claim 16, wherein a spectrum range of the compatible layer signal is [0, FL], a spectrum range of the compatible layer decoded signal is [0, FT], a spectrum range of the compatible layer bandwidth extension signal is [FT, FL], a spectrum range of the enhancement layer signal is [FX, FY], and a spectrum range of the audio output signal is [0, FY]; and
FL=FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or
FL=FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal; or
FL<FY, FX≤FT, and the audio output signal is determined in the following manner: a signal whose spectrum range is [0, FT] in the audio output signal is obtained by using the compatible layer signal, and a signal whose spectrum range is [FT, FL] in the audio output signal is obtained by using the compatible layer signal and the enhancement layer signal; or
FL<FY, FX>FT, and the audio output signal is determined in the following manner: a signal whose spectrum range is [0, FX] in the audio output signal is obtained by using the compatible layer signal, and a signal whose spectrum range is [FX, FL] in the audio output signal is obtained by using the compatible layer signal and the enhancement layer signal.
